(19) United States
(12) Patent Application Publication
(10) Pub. No.: US 2005/0044788 A1
(43) Pub. Date: Mar. 3, 2005

(54) Floating plant cultivation platform and method for growing terrestrial plants in saline water of various salinities for multiple purposes

(76) Inventors: Chung-Shih Tang, Kailua, HI (US); Wenhao Harold Sun, Ewa Beach, HI (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/821,806

(22) Filed: Apr. 9, 2004

Related U.S. Application Data
(60) Provisional application No. 60/461,901, filed on Apr. 9, 2003.

(51) Int. Cl. A01C 1/00; C09K 7/00

(52) U.S. Cl. 47/59 S; 75/711; 47/58.1 R

(57) ABSTRACT

The cultivation of terrestrial plants in brackish water or seawater is carried out with this invention. A light-weight, floating growth medium package (FGMP) or, alternatively, a sheet of suitable material is used to support the growth of terrestrial plants floating on water bodies of various salinity, including 100% seawater in marine environments. The FGMP units can be linked together and confined in a floating, rigid or flexible framework to form a floating seawater cultivation platform (FSCP). Using the method, plants were able to grow and thrive on the FSCP floating on 100% seawater in a sustainable manner. Halophytic akulikuli (Sesuvium portulacastrum L.) can regenerate its shoot and root in seawater. Thus, the discovery will enable us to practice marine agriculture, or agriculture on the sea. The FSCP can be used for wide range of purposes, from environmental protection to landscaping to crop production.

### RELATED APPLICATIONS

This application claims priority under 35 U.S.C. §119(e) to U.S. Provisional Application Ser. No. 60/461,901, filed Apr. 9, 2003, which is hereby incorporated by reference herein in its entirety.

### FIELD OF THE INVENTION

The present invention relates to the field of plant agriculture, and more specifically to the field of marine agriculture. Plants that are naturally terrestrial can be cultivated in a floating platform in an aqueous environment of various salinities using the methods of the invention.

### BACKGROUND OF THE INVENTION

A continuing challenge in food production is finding enough water and arable land to feed the world's population. Shortages of arable land and fresh water are among the most urgent global problems. Arable land is limited and its availability is shrinking. Forty-three percent of the earth's total land is arid or semiarid. Further, it has been estimated that 25 million hectares of agricultural land are lost every year as a result of soil salinity. As the world population continues to grow, steadily devouring existing farmland and water supplies previously used for crops, the demand increases for food and fresh water for human consumption.

In preparation for the future demand for additional sources of arable land, researchers have attempted to determine whether crops can be grown by irrigation of soils with seawater. One attempt involves the development of land-based seawater farming of salt-tolerant plants (such as Salicornia) by irrigation with seawater. The challenge, however, is that the majority of terrestrial plants are intolerant to high levels of salinity. The accumulation of salt in the soil when it is irrigated with seawater eventually kills even salt-tolerant plants because salt accumulation in soil eventually exceeds their tolerance limit. In some cases, frequent flushing of the soil with seawater lowers the salt build up, but the method still results in high salinity of the soil surrounding the roots of plants irrigated in this manner. For example, the salinity of the water bathing the roots of Salicornia exceeds 100 ppt (parts per thousand)—roughly three times the normal salinity of the ocean. It needs approximately 35 percent more irrigation when grown using seawater than conventional crops grown using fresh water (Glenn et al., 1998, Sci. Amer., 279: 56-61) the disclosure of which is hereby incorporated by reference it its entirety). The major cost for the seawater farm production of Salicornia is pumping seawater from the ocean for irrigation to flush salts below the root zone. An additional problem that can be anticipated from large-scale halophyte seawater farming will be the potential pollution of the underground water caused by the large volume of high-salt drainage water that also contains unused fertilizer.

Given the difficulty and prohibitive cost of creating additional arable land and/or producing the needed volumes of fresh water, an alternative approach that deserves serious consideration is innovative genetic engineering of plants that would allow them to thrive in environments that are currently not practical for crop growth. One such environment is the ocean, which comprises ninety-seven percent of the water on earth. What is needed is a method of growing land-based crops in brackish water or seawater, which would allow the use of many marginal, saline wastelands for hydroponic seawater culture and the use seawater for growth of terrestrial plants in fish ponds, bays, and near-shore environments. The ability to use seawater for key segments of agriculture would not only allow vegetables and grains to be cultivated in areas without arable land and freshwater, but also would free up much-needed land and fresh water for other agricultural and non-agricultural uses.

### SUMMARY OF THE INVENTION

Embodiments of the present invention include a plant cultivation system for growing terrestrial plants in saline water. The system includes: a plant support including a buoyant portion and at least one terrestrial plant in contact with the plant support, wherein the plant support is buoyant in the saline water, and wherein and at least a portion of the plant contacts the saline water. In some embodiments, the saline water can be, for example, seawater, brackish water, lake water, groundwater, pondwater or water in a reclamation, remediation, or cropping system, and the like. The saline water can be in open ocean, a coastal area, an estuary, a delta, a pond, a sump pond, a lake, an aquifer, a water reclamation facility, a phytoremediation site, a harbor, a marine agriculture farm, a desalination facility, and the like. The saline water further can include a contaminant such as, for example, a pesticide, an organic pollutant, a PCB, a hydrocarbon, a metal ion, nitrogen, phosphorous, and potassium. In some embodiments, the metal ion can be, for example, lead, mercury, cadmium, arsenate, copper, zinc, and any other metal ion. In preferred embodiments, the plant support can be a sheet material in contact with a buoyant edge or frame, and/or the plant support can be a growth medium or the like. The growth medium can be at least partially contained in a housing. The buoyant portion can be the growth medium, the housing, or both.

Additional embodiments of the present invention include a buoyant platform for growing terrestrial plants in saline water, which can have a sheet capable of being suspended at or near a surface of a body of saline water, at least one buoyant support member in contact with the sheet, and at least one terrestrial plant, plant part, or seed positioned in contact with the sheet and the saline water. A buoyant support member can form a supporting structure for the platform. The buoyant support member can be made of any suitable material, such as, for example, a natural material, a synthetic material, wood, bamboo, plastic, polypropylene, steel, fiberglass, foam, plastic, and rubber. The sheet can be made of any suitable material, such as, for example, shade cloth, a plastic film, netting, a textile, ground cover, screen, a woven material, a nonwoven material, bubble wrap, and styrofoam. In some embodiments, a space for growth of a terrestrial plant is present in a region between two buoyant support members.

In some embodiments, the buoyant platform can also include an irrigation system, which can deliver a liquid which can be, for example, evaporative water, rainwater, transpiration water, and freshwater. The irrigation system can further deliver a fertilizer, a nutrient, a mineral, and a plant growth regulator. The irrigation system can include a means of collecting irrigation water which has a lower salinity than the saline water. The irrigation system can also have a means of storing the irrigation water.

Additional embodiments of the present invention include a buoyant platform for growing terrestrial plants at a surface of a saline body of water, having at least one growth medium capable of being suspended at a surface of the saline body of water. The growth medium can have at least one terrestrial plant, plant part, or seed; and at least one buoyant support member supporting the growth medium. The growth medium can have at least one of the following: peat, peat moss, an artificial soil component, natural soil, a soil amendment, a hydrophobic particle, an organic fertilizer, and a plant growth nutrient, or manure. In some embodiments, the growth medium is contained in a housing which can be made of, for example, shade cloth, a plastic film, netting, a textile, ground cover, screen, a woven material, a nonwoven material, bubble wrap, or styrofoam. In some embodiments, an evaporation-protective layer can be present at a surface above the growth medium package to inhibit contact of the growth medium with air.

Further embodiments of the present invention provide for methods of growing a terrestrial plant in saline water, by providing a buoyant growth platform capable of being suspended at a surface of a body of saline water, placing plant material in the platform so that at least a portion of the plant material is contacted by the saline water, and growing at least one plant from the plant material while the platform is afloat in the saline water. In some embodiments, the plant material can be, for example, a seed, a cutting, a root, a whole plant, or a tuber. The plant material can be contacted with the saline water by, for example, direct contact, wicking, and irrigation. In some embodiments, the method also involves harvesting from the growth platform at least one of the following: a whole plant, a plant part, an inflorescence, a fruit, a flower, a seed, pollen, a leaf, a root, a tuber, a meristem, or a shoot. In some embodiments, the method also involves the use of the harvested plant material in a product or process such as, for example: food, oil extraction, fiber, fuel, spice, herbal formulation, a nutraceutical, a pharmaceutical, an economic crop, a phyto-salt, bioremediation, contaminant sequestration, a feed, a dye, a building material, or an industrial raw material. In some embodiments, the plant can be, for example, Salicornia spp., Rhizophora mangle, Batis maritime, Sesuvium portulacastrum, Myoporum sandwicense, Thespesia populanea, or Scaevola taccada. The plant can be a cultivated crop plant.

Additional embodiments of the present invention include methods of improving a quality of a body of saline water containing an undesired substance, by providing a buoyant growth platform capable of being suspended at a surface of a body of saline water containing an undesired substance, placing plant material in the platform so that at least a portion of the plant material can be contacted by the water, growing the plant material in presence of the water, removing the substance from the water, through accumulation of the substance in the plant material. The substance can be, for example, an organic compound, diesel fuel, gasoline, a metal, a pesticide, an organic pollutant, a PCB, a metal ion, nitrogen, phosphorous, or potassium.

Yet further embodiments of the present invention include methods of bioremediation of a ground area containing an undesired substance, by providing a sump pond, including water, at a low point of a ground area, wherein the ground area contains an undesired substance, providing a buoyant growth platform capable of being suspended at a surface of a the sump pond, placing plant material in the platform so that at least a portion of the plant material can be contacted by the water, growing the plant material in presence of the water, and removing the substance from the water, through accumulation of the substance in the plant material. In some embodiments, the water is added to the pond by leaching the ground area with water. In some embodiments, the plant material can be harvested. The steps of the method can be repeated.

Additional embodiments of the invention provide for methods of improving a saline fish habitat, by providing a buoyant growth platform capable of being suspended at a water surface of a saline fish habitat, placing plant material in the platform, such that at least a portion of the plant material can be contacted by the water, and growing the plant material in presence of the water under conditions permitting the growing plant material to improve the fish habitat. The plant growth can permit at least one improvement such as, for example, providing a food source to the fish, providing shelter to the fish, encouraging formation of a community of organisms beneficial to the habitat, removing an undesired substance from the water, or depositing a desired substance into the water.

Additional embodiments of the invention provide for methods of protecting land from seashore erosion, by providing a buoyant growth platform capable of being suspended in saline water adjacent a seashore, placing plant material in the platform so that at least a portion of the plant material can be contacted by the water, and growing the plant material in presence of the saline water to produce a break to protect against seashore erosion. The break can have at least one finction such as a wind break, a wave break, a fish sanctuary, and a landscaping feature.

Still other embodiments of the invention provide for methods of desalinating saline water, by providing a buoyant growth platform capable of being suspended in saline water adjacent a seashore, placing plant material of an ion-accumulating plant in the platform, such that at least a portion of the plant material can be contacted by the water, and growing the plant material in presence of the saline water such that a salt ion is accumulated in the plant material and removed from the water. The ion can be, for example, sodium, phosphorous, potassium, nitrogen, sulfur, and boron. The ion-accumulating plant can be, for example, Sesuvium portulacastrum.

Additional embodiments of the invention provide for methods of screening a plant variety for an ability to thrive in saline water, by providing a buoyant growth platform capable of being suspended in saline water, determining a first measure of at least one characteristic of material of a test plant variety, placing the plant material in the platform, such that at least a portion of the plant material can be contacted by the saline water, allowing a period for growth of the plant material, determining a second measure of the at least one characteristic of the plant material; and assessing ability of the plant material to thrive in saline water based upon a comparison of the first measure and the second measure. The characteristic includes at least one member of the group consisting of: biomass, size, shape, color, protein content, sugars content, growth rate, and developmental stage. In some embodiments, the test plant variety can be subjected to mutagenesis prior to or during growth.

While various embodiments of the invention have been summarized herein, it is noted that variations on numerous embodiments can include combinations of the features recited herein. Thus, mention of a feature in reference to or proximity to a particular group of embodiments does not imply that such feature is not combinable with other embodiments of the invention, including but not limited to those that are summarized herein.

### BRIEF DESCRIPTION OF THE DRAWINGS

FIG. 1. The floating growth medium package (FGMP) made of sealed polypropylene shade cloth bag containing hydrophobic synthetic foam particles such as Polylite EPS Flakes and natural soil amendments such as peat moss and peat. Size and shape of the FGMP can vary according to needs.

FIG. 2. A typical assembly of floating growth medium packages (FGMP) confined within the rigid PVC pipe framework. The units are tied together and secured to the framework with ropes. This floating seawater cultivation platform (FSCP) supports selected salt-resistant plant growth in a sustainable manner. The side view also shows roots protruding from the FGMP and suspending in the seawater. When the FSCP is cropped with plants capable of phytoremediation, the system is called floating phytoremediation platform (FPP).

FIG. 3. Floating seawater cultivation platform using ground cover and inflated plastic pipes. Plants are supported in-between the two air pipes and roots extrude through the ground cover.

FIG. 4A. Beach Naupaka (Scaevola taccada) in commercial potting mix showed healthy growth with daily irrigation of fresh water (L), but died after two months of irrigation with seawater (R).

FIG. 4B. Milo (Thespesia populanea) in commercial potting mix showed healthy growth with daily irrigation of fresh water (L), but died after two months of irrigation with seawater (R).

FIG. 5A. Milo (Thespesia populanea) growing on a floating growth medium package in 100% seawater for 8 months, with roots protruding from the package.

FIG. 5B. Naio (Myoporum sandwicense) growing on a floating growth medium package in 100% seawater for 8 months, with roots protruding from the package.

FIG. 5C. Akulikuli (Sesuvium portulacastrum) growing on a floating growth medium package in 100% seawater for 8 months, with roots protruding from the package.

FIG. 6A. A floating frame made of 2 inch PVC pipes. Nylon catching net is installed to prevent scattering of plant debris and fish grazing of the roots.

FIG. 6B. Demonstration of the floating seawater cultivation platform (FSCP). From L to R, plants are akulikuli (Sesuvium portulacastrum), naio (Myoporum sandwicense) and milo (Thespesia populanea).

FIG. 7. Demonstration of the floating seawater cultivation platform in coastal water at Heeia Fishpond, Kaneohe, Hi. Sesuvium portulacastrum plants were cultivated on FSCP in the brackish water at salinity of 18.5 ppt without additional fertilizers for five months. The plants inside of the catching net on the left were compared with the plants outside of the net on the right.

FIG. 8A: Shoot production of Sesuvium portulacastrum inside of the net on the left and outside of the net on the right in Heeia Fishpond after 5 months. The shoot growth was reduced without the protection by the catching net.

FIG. 8B: Root production of Sesuvium portulacastrum inside of the net on the left and outside of the net on the right in Heeia Fishpond after 5 months. The root growth was reduced without the protection by the net.

FIG. 9A: Regenerating Sesuvium portulacastrum shoots in brackish water 3 months after the shoots were cut at the upper surface of the FGMP while old roots remained.

FIG. 9B: Regenerating Sesuvium portulacastrum roots in brackish water 2 weeks after the roots were cut at the bottom surface of the FGMP while young shoots were growing.

FIG. 10: Floating seawater cultivation platform using heavy-duty polyethylene sheet and air bubble cushion.

### DETAILED DESCRIPTION OF THE PREFERRED EMBODIMENT

There is a worldwide need for finding successful methods of growing terrestrial plants using seawater, not only to save the dwindling fresh water resources and precious land space, but also to tap the rich mineral nutrients in seawater. The invention described herein is a novel approach to growing plants that thrive in brackish water or seawater. Marine agriculture—the direct cultivation of land-based crops on floating seawater cultivation platforms (FSCPs—can overcome the problems of land-based seawater farming. The success of the present invention is based on the finding that terrestrial halophytes can adapt to the normal salt concentration of seawater in a proper growth medium, but not much higher. Thus, while using seawater to irrigate terrestrial plants on land fails quickly due to salt accumulation, plant growth on the floating platform is sustainable because the salinity never exceeds that of the seawater. Further, the method of the invention has a considerable cost savings for plant production as compared to currently attempted methods of salt water irrigation: using floating cultivation platforms and growth management, the estimated cost for marine agriculture of a commercial crop of Salicornia is less than $4 per pound—a greater than 50% savings.

The present invention provides methods to grow terrestrial plants in waters of various salinity, including brackish water and 100% seawater. Plants are grown on buoyant cultivation systems that allow at least a portion of the plant to contact the saline water.

The term “buoyant” refers to the quality of being capable of floating. A “buoyant cultivation system” is capable of floating at the surface of a body of water in which it is placed. In some embodiments of the invention, a buoyant system, buoyant platform, buoyant support structure, buoyant ties and ropes, and also buoyant sheets or layers are contemplated. In other embodiments, the plant itself, or its growth medium, can provide or contribute to the buoyancy necessary to keep the entire system buoyant.

Several types of buoyant cultivation systems can be used. For example, in some embodiments of the invention, the platform can be a simple layer of any suitable material, arranged so that it floats or is suspended on the surface of a body of saline water, such as brackish water or seawater. The platform can have perforations in which the plants are placed. The shoots of the plants typically remain above water, while the roots are suspended in the saline water.

Sheet or Layer Version

The cultivation platform can be made in any style, as long as it is capable of suspending the plant so that it partially contacts the water. In a relatively simple mode, the platform can be a simple sheet or layer suspended at the surface of the water. The preparation of an exemplary sheet-style system is shown in Examples 2, 3, and 6.

The sheet or layer can be prepared from any suitable material. Exemplary suitable materials include but are not limited to a woven or non-woven material, a mesh, netting, shade cloth, plastic, a textile, ground cover, screen, metal screen, nylon screen, polypropylene shade cloth, polycarbonate, polyvinylbutyrate, polyamide, polyvinyl chloride, ethylenevinylacetate copolymer polyurethane, polystyrene, polyvinylidine, polypropylene, polyamides, polyacrylates, polycarbonates, bubble wrap, buoyant package filler material, composites, polysulfone, fiberglass, polyvinylidine difluoride, plastics, metallic materials, closed cell polymer foam, HDPE (high density polyethylene), reclaimed materials, recyclable materials, and the like. Preferably, the sheet is made from a material that has a buoyancy that is higher than that of the water where the FSCP will be located.

The layer can be self-floating, or can be supported by other materials that allow the platform to float. The plant can be placed in a perforation in one layer, so that the shoots are in the air while the roots are suspended freely in the liquid. The sheet may be of a single layer, or may be folded to form any desired shape. In a preferred embodiment, the shape is that of long narrow bags. In some situations, the plant itself may create the buoyancy to keep the platform afloat. Preferably, the plant will remain upright, with the shoots above the water line.

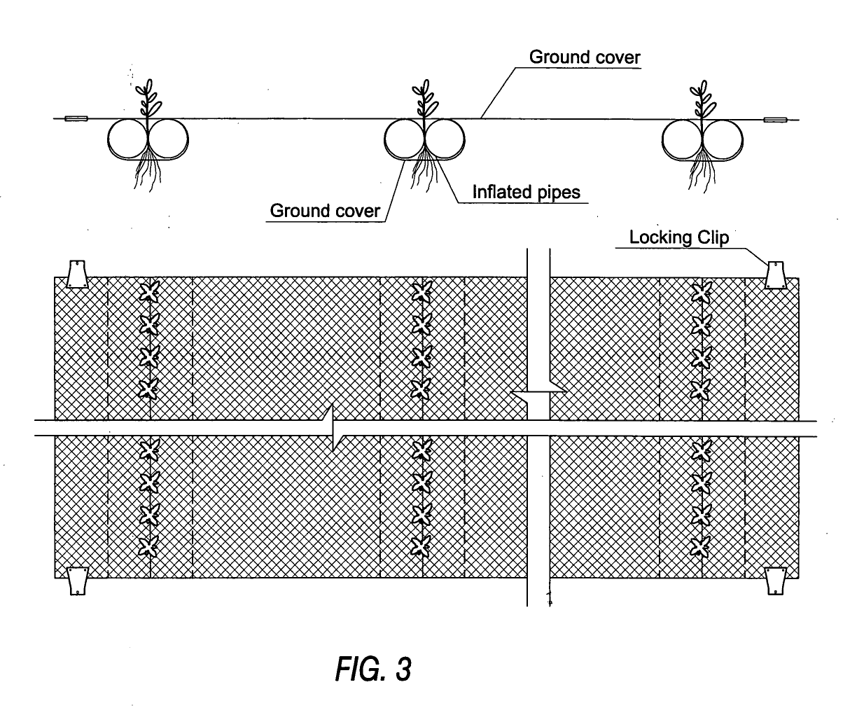

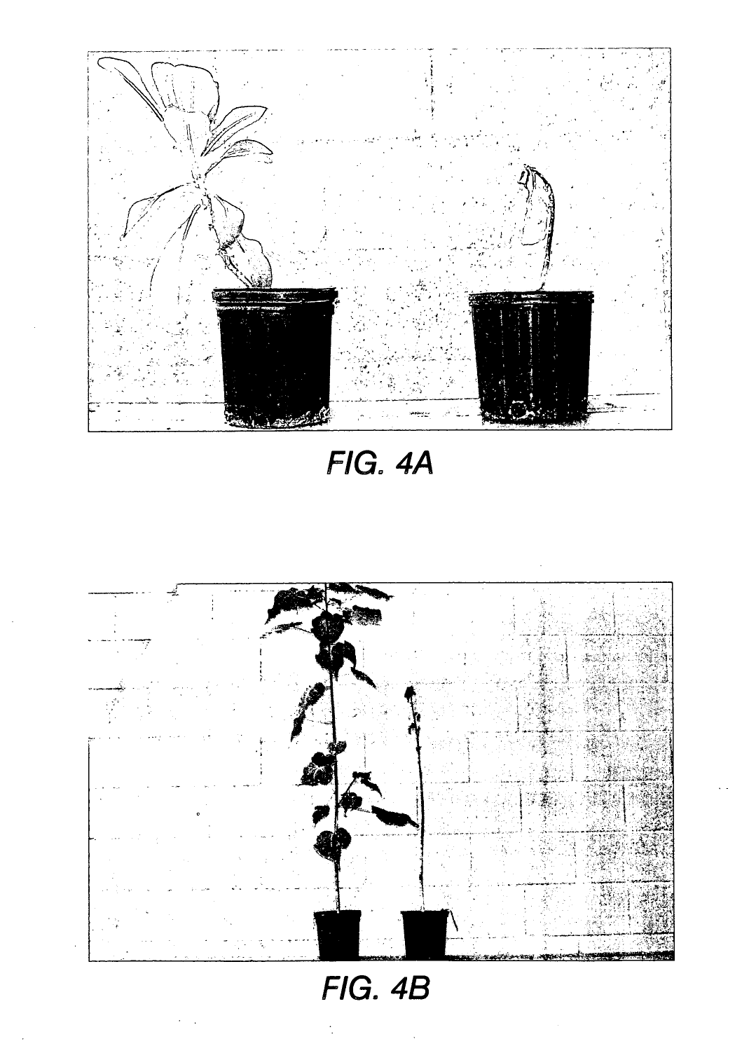

In some embodiments (see FIG. 3), a sheet of material is made into an “empty package” and the plant is placed in a perforation at the upper surface. The plant roots grow in the liquid, partially or entirely inside of the packaged area, thus protecting the roots from predators, while the upper portion of the plant is supported in an upright position by its placement in, for example, a perforated screen. The sheet or layer can be made from various materials. In preferred embodiments, the sheet is made from polypropylene ground cover which is folded over and clipped to make a packet. The bag can be supported by any means. The example shown in FIG. 3 is a support structure made of two plastic pipes supporting the platform, where the air pipes are made by blowing air into polyethylene tubing and sealing the both ends. In some embodiments, (and as shown in FIG. 3), the plant is inserted into a perforation between the two air tubes, so that the structural air tubes provide support for the growing plant.

Locking clips, cable ties, and any other suitable means can be used to anchor the ends. Each unit can be linked to an adjacent unit, using, for example, cable ties, ropes, string, wires, or other means to form a large scale platform.

In some embodiments of the invention, certain plant varieties are able to grow on the single layer of ground cover. In these situations, the sheet may be formed into a bag which is filled with a single air-inflated plastic pipe instead of two air pipes. This hollow-style FSCP is suitable for prostrate or dwarf plants that will not require a support system to keep the plants upright.

This provides an inexpensive and highly portable platform which is light in weight and low in cost. When the growth period is over, the air tubes can be deflated and the platform can be rolled up for storage or transport. The ability of the platform units to be rolled facilitates the marine agriculture engineering, e.g., mechanically planting and harvesting.

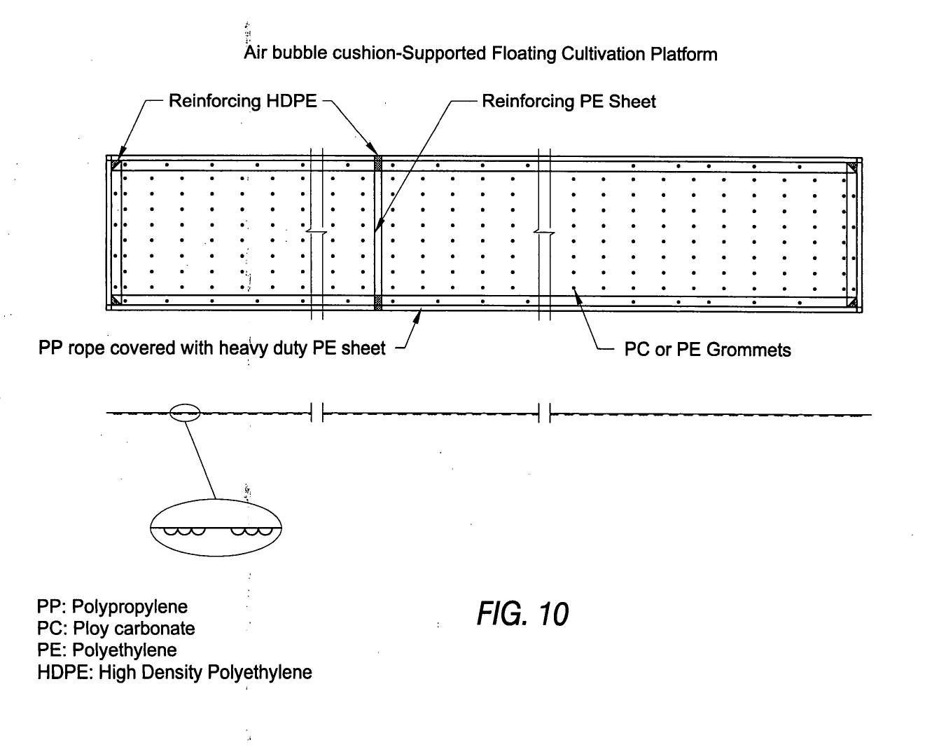

In some embodiments of the invention, one or more layers of air bubble cushion (packing material) can be used for the platform surface. In preferred embodiments, lightweight polypropylene rope floating on the surface of water surrounds the air bubble sheet. Example 6 provides an exemplary method for preparing such a platform. The details of this platform are illustrated in FIG. 10. Among the advantages of this platform are that it has an even floating force (allowing the plant to grow uniformly), is easy to transplant, and is suitable for mechanical production and operation.

Growth Medium Package

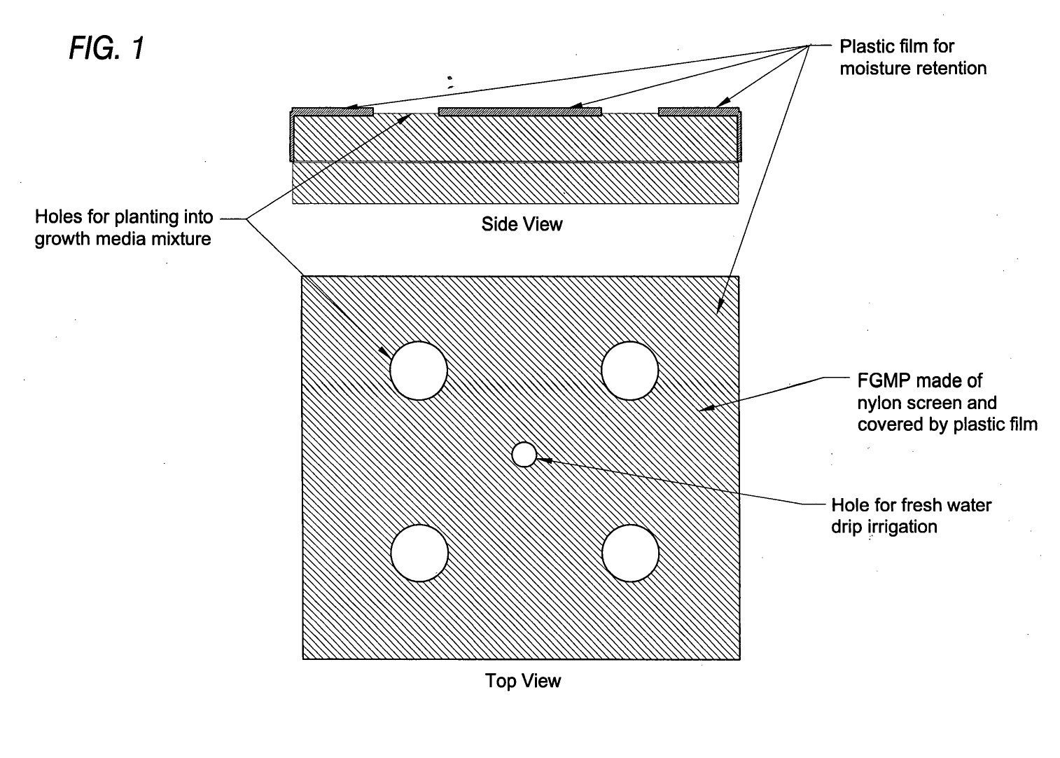

In other embodiments of the invention, a floating “growth medium package” (FGMP) is formed (FIG. 1), which contains filler materials suitable to allow root growth. In a preferred method of the invention, a package is made of polypropylene shade cloth containing a mixture of hydrophobic polymer foam particles and natural soil amendments or inflated plastic air pipes. A black plastic film wrapped around the upper part of the package. is used for moisture retention and maintaining a layer of low-salinity water. Drip irrigation can be used to control the salinity. An example of the preparation of such a FGMP is shown in Example 3.

The package material can be made out of any suitable material. Exemplary suitable materials include but are not limited to a woven or non-woven material, a mesh, netting, shade cloth, plastic, a textile, ground cover, screen, bubble wrap, metal screen, nylon screen, polypropylene shade cloth, polycarbonate, polyvinylbutyrate, polyamide, polyvinyl chloride, ethylenevinylacetate copolymer polyurethane, polystyrene, polyvinylidine, polypropylene, polyamides, polyacrylates, polycarbonates, composites, polysulfone, fiberglass, polyvinylidine difluoride, plastics, metallic materials, closed cell polymer foam, HDPE, reclaimed materials, recyclable materials, and the like.

The choice of filler material for the FGMP can vary widely. The material may be a mixture of components. Any material that allows root growth can be used. For example, the material may be made of synthetic materials, such as particles of closed cell polymer foam, hydrophobic polymer foam particles, or particles of open cell polymer foam, which is preferably coated. Examples of synthetic materials that may be fashioned into the filler material for the FGMP include but are not limited to polycarbonate, polyethylene methacrylate, polyvinylbutyrate, polyamide, polyethylene, polyvinyl chloride, ethylenevinylacetate, copolymer polyurethane, polystyrene, polyvinylidine, polypropylene, polyamides, polyacrylates, polycarbonates, bubble wrap, buoyant package filler material, composites, polysulfone, fiberglass, polyvinylidine difluoride, plastics, foamed plastics, metallic materials, closed cell polymer foam, and HDPE. The material may be made from reclaimed or recyclable polymeric materials, such as recyclable plastics, tires, and the like.

Additional exemplary materials that may be used for the FGMP filler material include but are not limited to peat, wood chips, bark or composted bark, natural materials, organic compost, or natural soils, vermiculite, polylite, potting mix, natural amendments, composted pine bark and other composted organic materials, yard waste, coconut pith, treated sludge, animal and/or vegetable-based landfill waste; wood and lignocellulose derivatives; vermiculite; perlite, glass beads; composted manure; organic fertilizer, chicken manure, sand; peat humus; agricultural waste (either composted or not); composted animal byproducts, wood and lignocellulose derivatives, reclaimed or recyclable materials, cork, and the like.

In some embodiments, a protective cover to prevent substantial evaporation is placed above the surface of the package.

Optional Irrigation

A layer of fresh-to-low-salinity water gradient, to allow growth of plants that are not as salt tolerant, can be maintained due to density gradient in the region of the platform. This gradient can be controlled, for example, by metered drip irrigation. The method of the invention is very flexible in that, by altering the method by, for example, the design of drip irrigation, package materials, the protective covering, or other methods, one can grow a wide range of plants having different levels of salt-resistance. In situations where fresh water is unavailable or expensive, Hawaiian halophytic plants successfully grown in 100% seawater as described herein demonstrate the practicality of this invention under extreme conditions.

When an additional irrigation system such as a drip or tape irrigation system (Drip Research Technology, San Diego, Calif.; DripWorks, Willits, Calif.) is used for additional fresh water irrigation, it can be modified for increased or decreased freshwater flow to allow growth of plants that less salt tolerant. Additional nutrients, fertilizers and plant growth regulators can optionally be applied using the drip system. A timer can be used to allow the drip system to work at certain hours, or the drip can be constant.

In some embodiments of the present invention, a battery powered or solar powered pump system is used to transfer fresh water from a storage area attached to the platform through the tubing of the drip irrigation system. In this way, the platform can be irrigated without the need for man power or electricity to run the pumping or timing system.

In some embodiments of the present invention, the system can be designed so that fresh water from the environment can be captured, optionally stored, and transferred to the plants growing on the FSCP system. In this method, the system can take advantage of the fresh water contained in rainfall or evaporation of the ocean water. A sloping platform extension can be fashioned to slope rainwater down to a holding area. For example, such a sloping platform extension could be made of a sheet of plastic that extends 2 feet beyond the platform on all sides, and is supported so as to ramp down to the platform. Water that falls on the top of the ramp extension drips downward to a collection device, and on to a storage area. Any water that condenses on the bottom of the ramped platform extension (such as from ocean evaporation) can be allowed to drip down through a collection device to a freshwater storage area. If desired, the transpirational water can also be recycled, using, for example, clear plastic sheeting above the growing plants which lets light in but allows transpirational water to slope down and drip back into the system. These water recycling systems can allow less salt-tolerant plants to grow using the FSCP system, without requiring human assistance to supply the fresh water.

This light-weight FGMP can be used to cultivate terrestrial plants. In some embodiments, the FGMP units can be linked together and confined in a floating, rigid or flexible framework to form a floating seawater cultivation platform (FSCP). Marine agriculture therefore is attainable by selecting salt-resistant plants through conventional screening, mutagenesis, training, genetic engineering, combinations thereof, and the like.

Support Structure

A supporting framework may be used to support the FSCP structure. The floating support member can be chosen from any suitable material, as long as it is buoyant in the water in which the particular FSCP will be located. Preferably, the support material does not degrade easily in an aqueous solution and is not corroded by saline solutions. The structural framework can be made from any suitable material. Examples of suitable forms include but are not limited to pipes, bags, tubes, air bubble cushion, packing material, balloons, buoy systems, floating scaffolding, and the like. The structure can be made from synthetic materials, such as, for example, closed cell polymer foam. The material may also be formed, for example, from an open cell polymer foam (preferably coated) shape covered with an airtight seal. Exemplary materials include but are not limited to polycarbonate, polyvinylbutyrate, polyamide, polyvinyl chloride, ethylenevinylacetate copolymer polyurethane, polystyrene, polyvinylidine, polypropylene, polyamides, polyacrylates, polycarbonates, bubble wrap, buoyant package filler material, composites, polysulfone, fiberglass, polyvinylidine difluoride, plastics, metallic materials, HDPE, reclaimed materials, recycled materials, air filled plastic tubes with sealed ends, metals, and the like. Preferably, the structure is made out of a rigid or flexible polymer material and provided with a water proof seal. Alternatively, the support structure may consist of a floating metal frame with a hollow interior.

The support structures can be prepared using conventional known molding processes. Exemplary methods for preparing such molded support structures include but are not limited to injection molding; extrusion molding methods such as T die extrusion molding, contour extrusion molding, pipe extrusion molding and inflation molding; vacuum molding, direct blow molding, injection blow molding, monoaxial stretching, tubular stretching, serial or simultaneous biaxial stretching with a tenter, press molding rotational molding, melt spinning, solution spinning, melt blowing, casting, calendering, and the like.

The support structures may also be made from natural materials. Exemplary natural materials include but are not limited to reclaimed or recyclable materials, wood and lignocellulose derivatives, bamboo, and the like. Additionally, the support structures may be made of a mixture of components.

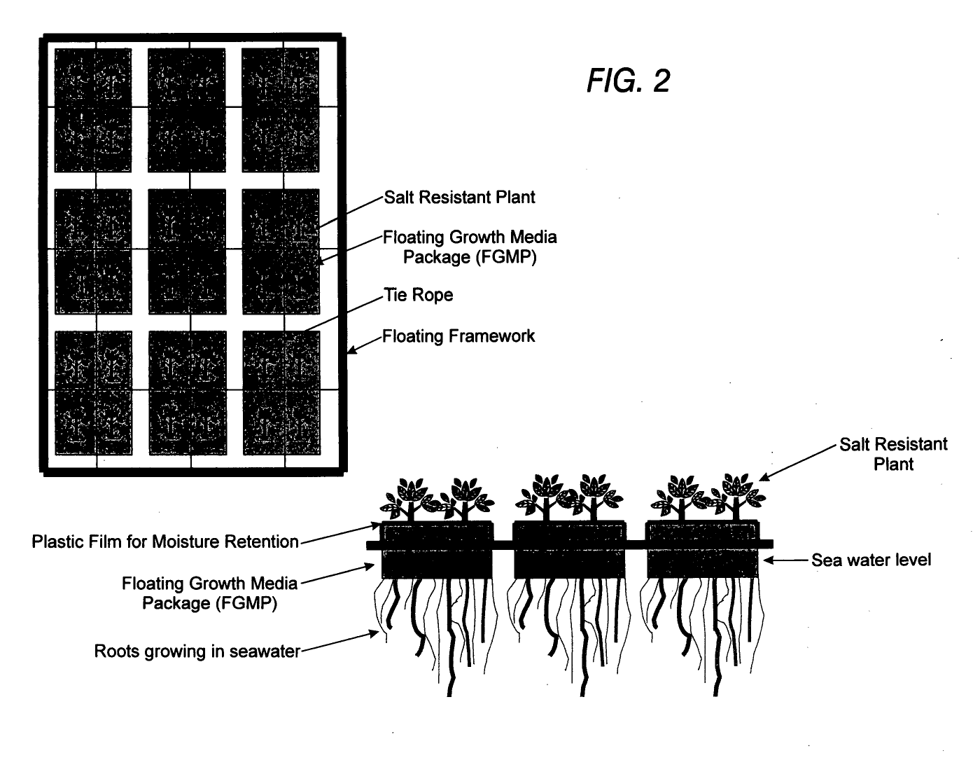

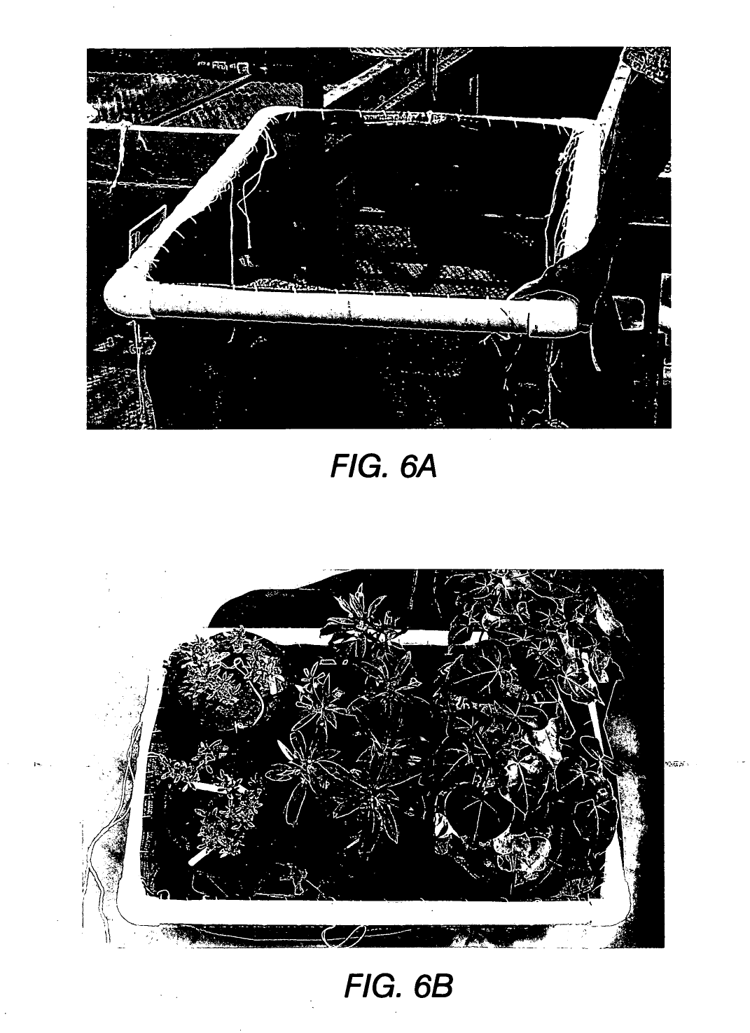

An example of such a supporting framework is illustrated in FIG. 2, FIG. 6A and FIG. 6B. The framework serves to contain the floating FGMPs which are strung together and tied or linked to the framework. The framework also can define the shape and dimensions of the FSCP. The framework can also be helpful to allow the platform to resist adverse weather conditions, to be towed, or anchored to the selected sites.

In a preferred embodiment, air-filled plastic tubes are used to support the framework. These air-filled tubes are lightweight, economical, and additionally allow the system to be deflated and transported to a new location or storage location readily. FIG. 3 displays the use of such air-filled tubes to support a sheet or layer upon which terrestrial plants can grow. The air filled tubes are preferably used for supporting the sheet or layer version of FSCP, but can also be used to support the FGMP version of FSCP if they are buoyant enough to cause the platform to float.

Optionally, a catching net may be used to protect the roots of the plant from overgrazing. The net may be attached to the framework as illustrated in FIG. 6A, or may be attached by any other means. Example 13 demonstrates that the catching net was useful in protecting roots from grazing and resulted in increased biomass.

The individual sheets or packages can be linked by any means into any desired size or shape. Suitable materials to connect multiple sheets or packages include but are not limited to rope, tie materials, string, clips, fasteners, sealing devices, clips, snaps, rivets, pins, and the like.

To allow the plant to be inserted into the sheet or package, in preferred embodiments a perforation or space is provided. The perforations can be designed to any size, as needed, and can be placed in any suitable pattern. Alternatively, if the spaces in the sheet or package are large enough, the plants can be placed directly through the spaces already present in the material. This depends on the size of the plant and the size of spaces in the sheet or package.

The FPP system has relatively few maintenance items, but periodic inspections can be useful to evaluate how the FPP system performed, and to replace or repair damaged materials or FSCP structures as needed. Post storm inspections can be made as soon as floodwater conditions have subsided. In order to prevent debris buildup, any blocked materials can be removed by cleaning weekly or more frequent if necessary.

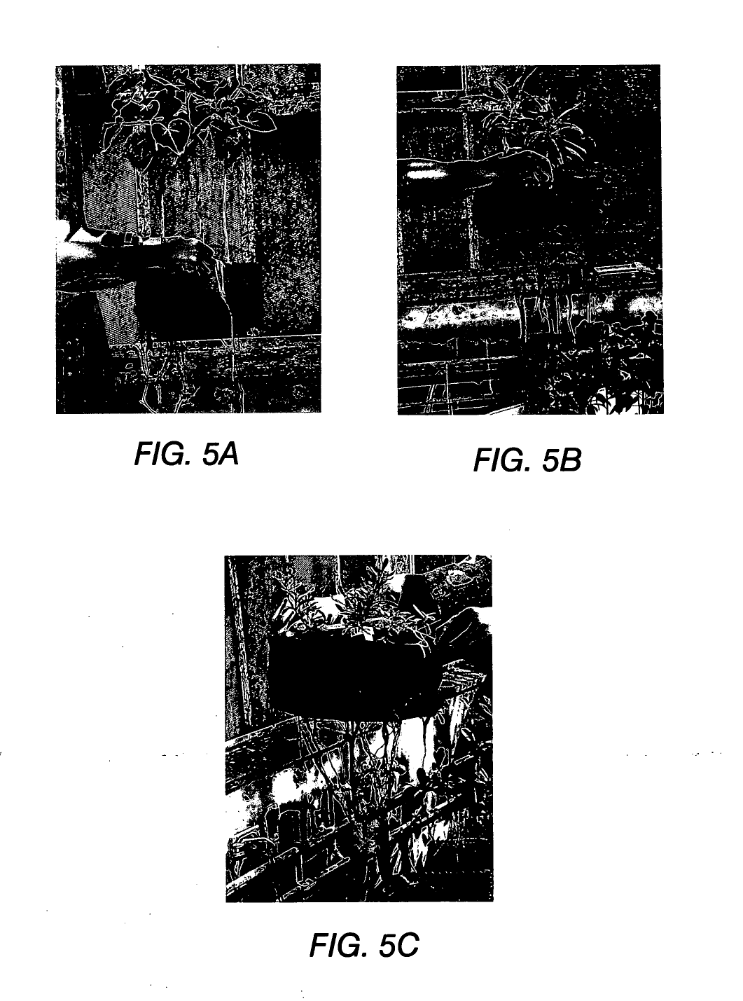

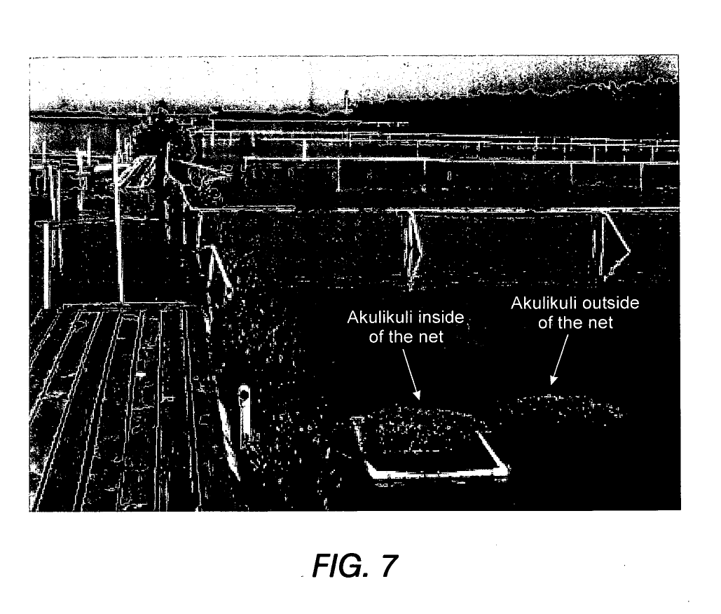

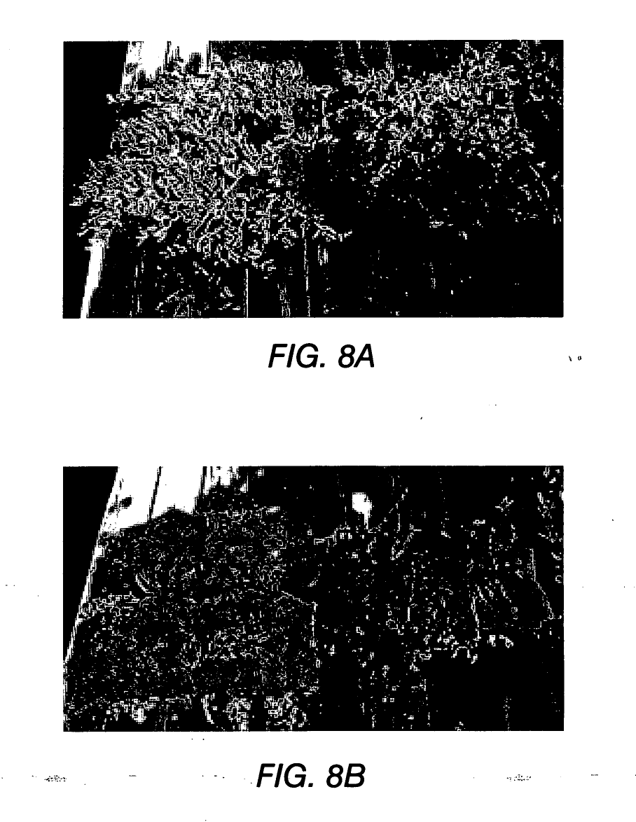

The cultivation of the terrestrial, preferably salt-tolerant plants in seawater demonstrates the feasibility of this concept of platform-based marine agriculture. As a demonstration of the invention, several salt-resistant Hawaiian plants, such as akulikuli (Sesuvium portulacastrum L.), milo (Thespesia populanea), naio (Myoporum sandwicense), beach naupaka (Scaevola taccada) and seashore paspalum (Paspalum vaginatum Sw.) have been found to be capable of sustainable growth on an artificial growth medium package (FGMP) floating in 100% seawater, although some of these plants require a training period of growing initially in diluted seawater (FIGS. 5A, 5B, 5C). The success of the invention is due to the concept that these terrestrial halophytes can adapt to normal salt concentration of seawater in a proper growth medium, but not much higher. Thus, while using seawater to irrigate terrestrial plants on land fails quickly due to salt accumulation from evaporation, plant growth on a floating platform of the invention is sustainable since the salinity never exceeds that of the seawater. Roots of these plants are able to form a rhizosphere in the growth medium package that is similar to that in the soil. Further, the roots also protrude from the package to form a suspending root mass (FIG. 5A 5B, 5C). Hawaii coastal seawater was used in the initial experiment, but most of the experiments were carried out in the artificial seawater made from the crystal sea marine mix (Marine Enterprises International, Inc.). When reconstituted, the composition is very similar to that of the seawater (Table 1). All of the selected plants can grow indefinitely on FSCP under the greenhouse condition, for akulikuli, the roots can reach one meter in length in six months. Akulikuli is able to grow in coastal water at salinity of 18.5 ppt in Heeia Fishpond, Kaneohe, Hi. (FIG. 7, FIG. 8A, and FIG. 8B). The plant produced approximately 25 g dry root matter and 50 g dry shoot mater per ft² in five months under field conditions (1.9 ppm N, 0.2 ppm P and 245 ppm K) without addition of fertilizers.

Transplant Process

The plants to be grown on the platform can be started from seed, plant parts, cuttings, or any other suitable means. In some embodiments, the plants are started on a place other than the platform, and are transplanted to the platform once they reach a certain size. Alternatively, the seeds, plant parts, cuttings, or other suitable starting material may be grown directly on the platform, without the need for transplanting. The choice of method may depend on costs and specific growth characteristics of each plant variety.

The plant growth medium may optionally have fertilizer, which in preferred embodiments is a slow-release fertilizer. The fertilizer may be applied through the drip irrigation system. Alternatively, no fertilizer is applied, and the plant is capable of obtaining all necessary nutrients from the saline water.

Choice of growing method may depend on the size/shape of plant, the salt tolerance of the plant, the harvesting methods, resistance of plant to wind and other environmental elements, resistance of plant to biological pests, and the like. For example, some plants may thrive well using the sheet or layer FSCP system, while others may thrive best when planted in the FGMP with added irrigation and nutrients.

Any part of the plant can be harvested, and will depend on the choice of plant variety and harvesting methods. Portions of the plant that can be harvested include but are not limited to the whole plant, a plant part, inflorescence, fruit, flower, seed, pollen, leaves, grains, plant roots, plant shoots, and the like. Thus, in some embodiments of the invention, the entire plant can be harvested, while in other embodiments, specific plant parts are harvested, allowing the plant to regenerate the part for a continuous cycle of harvests. The harvested material can be used for any desirable purpose. The harvested material can be used, for example, for food, feed, seed production, oil, fiber, a “phytosalt,” bio-fuel, spices, herbs, nutraceuticals, pharmaceuticals, dyes, building material, industrial raw material, economic crops, and the like.

The plants growing on the FSCPs of the invention can be a monoculture. Alternatively, a mixture of plants can grow on the platform.

Choice of Plant to Use

Although salt-tolerant plants such as akulikuli are particularly suitable choices for the marine agriculture methods described herein, it is envisioned that most types of terrestrial plants can be grown on the floating platforms of the invention.

As used herein, the term “plant” refers to either a whole plant, a plant part, a plant cell, or a group of plant cells, such as plant tissue, for example. Plantlets are also included within the meaning of “plant.” Plants included in the invention are any plants amenable to growth on the floating platforms of the invention, including angiosperms, gymnosperms, monocotyledons and dicotyledons.

Examples of monocotyledonous plants include, but are not limited to, asparagus, field and sweet corn, barley, wheat, rice, sorghum, onion, pearl millet, rye and oats. Examples of dicotyledonous plants include, but are not limited to tomato, tobacco, cotton, rapeseed, field beans, soybeans, peppers, lettuce, peas, alfalfa, clover, cole crops or Brassica oleracea (e.g., cabbage, broccoli, cauliflower, brussel sprouts), radish, carrot, beets, eggplant, spinach, cucumber, squash, melons, cantaloupe, sunflowers and various ornamentals. Examples of woody species include poplar, pine, sequoia, cedar, oak, fir, hemlock, ash, cherry, grapevines, berry vines, and the like.

Examples of plants that can be used include naturally salt tolerant plants, or partially salt tolerant plants, plants that can be adapted to salt tolerance, plants that are genetically engineered or bred by conventional means for increased salt tolerance. Additionally, by altering the design of the platform and method somewhat, such as by irrigating the platform from above with fresh water using a drip or spray mechanism, plants that are typically considered less salt tolerant can adapt and thrive while growing on the platform.

In some embodiments of the invention, plants that are naturally somewhat salt tolerant can be more readily grown using the FSCPs.

In addition to the prostrate herb, akulikuli (Sesuvium portulacastrum L.), several salt- tolerant plant varieties have been successfully grown in 100% seawater using a FGMP system of the invention in the greenhouse. These selected salt-resistant plants are grass: seashore paspalum (Paspalum vaginatum Sw.), small shrubs: naio (Myoporum sandwicense), beach naupaka (Scaevola taccada), herbs: sea asparagus (Salicornia spp.) and akulikuli kai or Pickleweed or saltwort (Batis maritime), trees: milo (Thespesia populanea), and red or American mangrove (Rhizophora mangle). Some of these plants for example, naio and naupaka, may require an adaptation period of growing initially in diluted seawater.

Examples of other crops that are salt tolerant or moderately salt tolerant, include but are not limited to beets, kale, cotton, triticale, some wheat spp., wildrye, saltgrass, spinach, wild wheat, Distichlis spp., lentils, oats, rice, sorghum, field corn, flax, sunflower, artichoke, asparagus, squash, alkaligrass, barley, rye, Atriplex, Elymus, Hedysarum, Kochia, Myoporum, Nittraria, Puccinellia, Coccoloba uvifera, Salicornia, Salsola, Suaeda Acacia, Casuarina, Eucalyptus, Hedysarum, Lotus, Medicago, Melaleuca, Prosopis, Salicornia, Tamarix, Tetragonolobus, Thizophora, alkali sacaton, saltgrass, nuttall alkali grass, Bermuda grass, Rhodes grass, rescue grass, Trifolium, Beta maritima, Mesembryanthemum spp., Salvadora persica, S. oleoides, Lycium spp., Santalum acuminatum, Salicornia virginica, Salicornia bigelovii, Rhizophora mangle, Batis maritima, and the like. Because of their tendency toward salt tolerance, these plants are especially likely to thrive in the FSCP system.

Some plants, although initially salt sensitive, can become adapted to growing on the FSCP, by slowly transferring the plants to aqueous solutions of successively higher levels of salinity. An example of a salinity adaptation procedure is described in Example 16. In some embodiments, the plants grown in the floating platforms may be selected to have increased salt tolerance, for example by conventional plant breeding practices.

Further, genetic engineering is capable of producing plants with increased salt tolerance. Accordingly, in some embodiments, the plants used on the FSCPs can be genetically modified or genetically engineered for increased salt tolerance, or for increased yield in saline water, such as brackish water or seawater, as compared to non-engineered plants.

Accordingly, in some embodiments, the plants to be grown in the floating platforms may be genetically modified to have increased salt tolerance. The term “genetic modification” as used herein refers to the introduction of one or more heterologous nucleic acid sequences into one or more plant cells which can then be used to generate whole, sexually competent, viable plants. The term “genetically modified” as used herein refers to a plant which has been generated through the aforementioned process. Examples of the use of FSCPs to grow genetically modified plants are shown in Examples 20 and 21.

Some plants may grow best in waters of low salinity, even with the added freshwater irrigation drip system. For these types of plants, the FSCPs can be located in bays or fishponds with lower salinity levels.

The method of the invention can be used for marine landscaping, for example, by growing floating salt water decorative plants. FSCPs carrying decorative plants that are salt tolerant may be useful for bay or marina landscaping. These can have the added advantage of cleaning the water by removing some turbid materials and pollutants such as diesel, oil, gas, or other materials that may be present in the water in addition to adding an aesthetic appeal to the waterway.

Choice of Saline Water to Use

The FSCPs of the invention can be suspended in any size body of water. Exemplary bodies of water include but are not limited to natural ponds, artificial ponds, aquarium tanks, aquaculture ponds, salt water lakes, fisheries, deltas, ground water, pond water, lagoons, sloughs, bays, sump ponds, aquifers, water reclamation facilities, desalination facilities, coastal ocean waters, open ocean waters, remediation systems, cropping systems, golf course ponds, bogs, brines, tidal marshes, swamps, estuaries, phytoremediation sites, harbors, marinas, marine agriculture farms, boating facilities, and the like.

The dissolved salt elements present in seawater include sodium, potassium, magnesium, calcium, manganese, chlorine, sulfur, bromine, and other elements. Accordingly, many of the nutrients needed for terrestrial plant growth are already present in seawater. Minimal nutrient addition may be needed, which can be administered by drip irrigation, or may be present in the growth medium package, preferably as slow release fertilizer. The amount used may depend on the rate of plant growth, nutrient requirements, and other factors.

The FSCPs can be used to grow terrestrial plants in saline water of various salinities. The term “salinity” refers to a measure of the amount of salts dissolved in water. Bays, lagoons, and estuaries exhibit a range of salinity as they are places where saline ocean water mixes with fresh water. Salinity measurements are typically expressed in parts per thousand (ppt). The salinity of freshwater typically ranges from 0 to 1 part per thousand (ppt). Brackish water is considered slightly salty and typically ranges from about 1 to about 32 ppt. The salinity of seawater is typically anything over 30 ppt. Salinity levels in bays may be around 20-30 ppt. The salinity of the open ocean is about 35 ppt. The level of ocean salinity near the mouth of a bay may be slightly less due to dilution, and the salinity of bays and estuaries is typically further diluted. Salinity levels of a body of water can also fluctuate, for example, with movement of the tides, dilution by rain or snow, and mixing of the water by wind.

The FSCPs can be placed in bodies of saline water with various salinities. For example, the FSCPs may be used in saline waters with various salinity levels of from about 3, 5, 7, 9, or 10 ppt to about 32, 33, 34, 35, 36, 37, 39, or 41 ppt. In some embodiments of the invention, the plants are grown in salinity levels from about 12, 15, 18, to about 21, 24, 27, or 30 ppt.

The term “saline water” refers generally to water with an amount of salt present. Generally, the term “Fresh water” refers generally to water of less than 1,000 ppm salt. The term “slightly saline water” refers generally to water of from about 1,000 ppm to about 3,000 ppm salt. The term “moderately saline water” refers generally to water from about 3,000 ppm to about 10,000 ppm salt. The term “highly saline water” refers generally to water from about 10,000 ppm to about 35,000 ppm. Ocean water typically contains about 35,000 ppm of salt.

The FSCPs can be used to grow plants in bodies of water ranging from 0% to 100% seawater. For example, the plants can be grown in from about 0%, 5%, 10%, or 20% seawater, to about 70%, 75%, 80%, 85%, 90%, 95%, or 100% seawater. Further, plants can be grown in from about 25%, 30%, 40%, to about 50%, 60%, or 65% seawater. The FSCPs may utilize brackish water, freshwater that has been polluted with saline contaminants, saline fish ponds, natural seawater, or may utilize a synthetic seawater preparation. For example, for experimental purposes, synthetic seawater can be prepared as described by the manufacturer (Crystal Sea® Marinemix; Marine Enterprises International, Inc., Baltimore, Md.). Exemplified contents of such artificial seawater are shown below in Table 1.

TABLE 1
Properties of ocean water and the artificial seawater (crystal seawater)
made with Crystal Sea ® Marinemix (Marine Enterprises
International, Inc.).

| | | Crystal |
|---|---|---|
| Property | Ocean water | seawater |
| Concentration of ions (mg L⁻¹)) | | |
| K | 389.0 | 300.0 |
| Na | 12074.0 | 10794.0 |
| Ca | 491.0 | 399.0 |
| Mg | 1455.0 | 1185.0 |
| Fe | 0.9 | 1.2 |
| Cu | 0.8 | 0.9 |
| Zn | 0.8 | 0.7 |
| pH | 7.9 | 8.3 |
| Electric conductivity (mmhos cm⁻¹) | 47 | 41 |

The seawater can be diluted to any concentration desired. For example, the artificial seawater can be diluted to test the ability of a given plant variety to grow in a saline solution. The artificial seawater can be used to create an artificial growing area for the platforms. The artificial seawater can additionally be used to adapt young plants to be eventually transplanted to the FSCPs by slowly adapting the plants from a low saline to a higher saline environment.

Advantages

There are several advantages to growing plants using the method of the invention. First, irrigation is not necessary for plants tolerant to seawater salinity. Growth of certain plant varieties may require some fresh water irrigation, but this amount would be much less than the amount typically used to irrigate the same plant varieties when growing in soil. Accordingly, the method is particularly valuable in situations where fresh water availability is low.

An additional advantage of the invention is that there is a minimal requirement for administration of additional nutrients (fertilizer). Much of the required nutrients can be obtained from the brackish water or seawater itself, and additional nutrients, if needed, can be administered efficiently using a drip system or slow release fertilizer.

A further advantage of the method of the invention is that the platform can be designed for high mobility. Thus, in some embodiments of the invention, the platform can be easily dismantled and set up at another location, for example, in response to changes in weather conditions, or seasonal changes in crops to be grown on the platforms.

The flexibility of the platforms of the invention allow for growing many types of plants on many types of aqueous bodies. The size, shape, and dimensions of the platform can be designed to fit desired needs. For example, the platform can be arranged to be used for a small natural pond, a golf course pond, an artificial pond (such as a fish pond), or can be designed for use in a lagoon or bay setting. Further, the method can be designed for use in coastal waters, or in the open ocean.

Examples of uses for the cultivation system of the invention include but are not limited to growing ornamental crops for landscaping or production, for food, feed, oil, fiber, production of nutraceuticals and pharmaceuticals, building materials, industrial raw materials, dyes, biofuel, medicine and dietary supplements, and other economic crop production, for the modification of environment such as enriching fish population, desalination, phytoremediation, and the like.

Various uses of the Cultivation Platforms

Parallel to practicing agriculture on land, there are many possible uses of FSCP on the sea or in brackish marsh or estuary environment, especially where the water is relatively calm (e.g., a harbor, lagoon and coastal fishpond). Through selection, training, breeding, or genetic engineering, any plant reaching a salt tolerance equal to or higher than the normal salt concentrations of seawater will be eligible for growing on FSCP in the sea. Optimal conditions for growth will vary from plant variety to plant variety, but nitrogen and phosphate are the two nutrients that are needed for healthy growth. Irrigation is not necessary, but a low rate of drip-irrigation will enhance growth in many cases and expand the range of plants adaptable to the FSCP system.

The FSCP may be used for bioremediation of saline bodies of water. Examples 9, 10, 11, 17, 22, and 23 illustrate exemplary methods of bioremediation of saline areas using FSCPs. Bioremediation using plants has been used for decontaminating soil. The method is termed “phytoremediation” or “phytoextraction,” which is the use of plants to scavenge organic or inorganic contaminants, such as pesticides, PCBs, and heavy metals from the soil. Excess amounts of nitrogen, phosphorous, and potassium in a body of saline water can also present a pollution problem that can be ameliorated using methods of the invention.

Some plant species appear to be able to absorb even high levels of metals or other contaminants. Such plants are sometimes called hyperaccumulators or metallophytes. These hyperaccumulators may be preferred choices for bioremediation of saline bodies of water using embodiments of the present invention. Certain plants have been found that accumulate nickel (Brooks et al., 1979), cobalt and copper (Brooks et al, 1978), manganese (Brooks et al., 1981), lead and zinc (Reeves and Brooks,), zinc and cadmium (Brown et al., 1994), and selenium (Banuelos and Meek). An example of a lead accumulator is Brassica juncea, the Indian mustard plant (Kumar et al., 1995).

Although bioremediation has been successfully applied in many polluted terrestrial sites and freshwater environments, little to no information is available about its use in estuary or marine environments, where salt concentrations are high. The major constraint is that unlike terrestrial plants, submerged marine algae do not normally have a large rhizosphere where bioremediation usually takes place, and there are no salt water aquatic plants equivalent to freshwater plants such as the water hyacinth (Vesk and Allaway, Aquatic Botany, 59:33-44 (1997)).

The FSCP can be used to establish a mono- or mixed-plant community, nourishing a rich population of microorganisms in the rhizosphere through root exudation. The microorganisms may in turn promote availability of nitrogen (e.g., rhizobia, Azotobacter paspali (Dobereiner and Day. In: “Nitrogen Fixation by Free-Living Microorganisms.” Stewart, ed., Cambridge Univ. Press, Cambridge, UK, pp. 39-56 (1975)) and phosphorous (e.g., micorrhizae) (Habte and Fox, Plant Soil, 151:219-226 (1993)), as well as enhance the tolerance of plants to adverse environmental conditions such as high salinity and heavy metals (Bradley et al., The New Phytologist, 91:197-201 (1982); Pond et al., Mycologia, 76:74-84 (1984); Jindal et al., Plant Physiology and Biochemistry, 31:475-481 (1993); Bethlenfalvay, In: “Mycorrhizae in sustainable agriculture.” Bethlenfalvay and Linderman, eds., ASA/CSSA/SSSA, Madison, Wis., pp. 1-27 (1992), the disclosures of which are hereby incorporated by reference in their entireties), and degradation, chelation and transportation of pollutants (Brodkorb and Legger, Applied and Environmental Microbiology, 58(9):3117-3121 (1992); Beveridge and Fyfe, Can J Earth Sciences, 22:1893-1898 (1985); Ferris et al., Nature, Lond 320:609-611 (1986), the disclosures of which are hereby incorporated by reference in their entireties). Thus, a FSCP of the invention can finction as a “floating phytoremediation platform” (FPP) when selected plants are established. In some embodiments of the invention, the FPP is a functional and sustainable phytoremediation facility strategically placed in a marine environment. For instance, while deployed, the FPP can absorb and degrade target surface water pollutants, such as petroleum hydrocarbons from the floating sheen that is common around boat marinas. FPP can outperform the current state-of-the-art technology, oil-adsorbing spill control booms, through near perpetual regeneration of the pollutant adsorption/degradation capacity. Additionally, fertilizer application is not generally required for phytoremediation platforms. Plant roots and shoots may be harvested manually or mechanically every 6 to 12 months depending on the growth rate. Trace metals (zinc, copper and lead), phosphorous and nitrogen contents of selected plant tissues can be analyzed in a commercial analytic laboratory before harvesting in order to determine how to utilize the biomass.

The FSCP method can be used for in-situ phytoremediation of heavy metals in marine environments. As used herein, the term “metal” preferably refers to metal ions that are found in a metal-containing contaminated environment. It will be appreciated that this term will also include elemental metal that is not in an ionic form. Plants may take up and accumulate one type of metal, or may take up and accumulate more than one metal, or a mixture of several metals. The metals that can be accumulated according to the method of the present invention include stable metals and radioactive metals such as lead, chromium, mercury, cadmium, cobalt, barium, nickel, molybdenum, copper, arsenic, selenium, zinc, antimony, beryllium, gold, manganese, silver, thallium, tin, rubidium, vanadium, strontium, yttrium, technetium, ruthenium, palladium, indium, cesium, uranium, plutonium, and cerium. The term “metal” also includes mixtures of metals and common organic pollutants such as, for example, lead or chromium in combination with nitrophenol, benzene, alkyl benzyl sulfonates, polychlorinated biphenyls (PCBs) and/or halogenated hydrocarbons. An additional description of metals and contaminants that can be accumulated by terrestrial plants is found in U.S. Pat. Nos. 5,785,735, 5,876,484, and 5,927,005, the disclosures of which are incorporated by reference herein in their entireties.

As an example of heavy metal contaminants in saline water, the release of copper from ship paints to the coastal marine environment significantly increased as a result of the substitution of copper-based ship paints for tri-n-butyltin antifouling paints (Stephenson and Leonard, Marine Pollution Bulletin, 28:148-153 (1994); Gustavson et al., Hydrobiologia, 1:125-138 (1999); Claisse and Alzieu, Marine Pollution Bulletin, 26:395-397 (1993), the disclosures of which are hereby incorporated by reference in their entireties). The toxicity of the metal to marine organisms has become a serious problem worldwide (Nagatomo et al., Journal of Shimonoseki University of Fisheries, 41:167-178 (1993), the disclosure of which is hereby incorporated by reference in its entirety), threatening marine and estuarine ecosystems (Sunda et al., Estuarine Coastal and Shelf Science, 30:207-222 (1990); Reichelt-Brushett and Harrison, Marine Pollution Bulletin, 38:182-187 (1999), the disclosures of which are hereby incorporated by reference in their entireties). There is an urgent need and an increasing attention for prevention and remediation for copper and other marine metal pollutants (U.S. Environmental Protection Agency, National Science Foundation, Office of Naval Research and DOD/DOE/EPA Strategic Environmental Research and Development Program. Joint Program on Phytoremediation. See, hypertext transfer protocol es.epa.gov/nceqa/rfa/phytore00.html, pp. 1-11 (2000), the disclosure of which is hereby incorporated by reference in its entirety). The success of the FSCP method in seawater can fulfill this need.

Using the FPP, akulikuli (Sesuvium portulacastrum L.), an indigenous Hawaiian halophytic plant in Aizoaceae family has been identified as a copper excluder (Baker, Journal of Plant Nutrition, 3:643-654 (1981)), which accumulates higher concentrations of heavy metals in the roots than that in the shoots (Example 9 and Table 2). Akulikuli is able to quickly establish an extensive root system first in the FPP platform, then penetrate through the platform to form a suspended root mass in seawater. Roots reached over one meter in length within 6 months under the cultural conditions. This rhizospheric (in the platform) together with the suspended (in seawater) root system effectively removed copper ion from seawater. After growing in seawater amended with 35 mg L⁻¹ copper for 1 day, the roots, stems and leaves contained 4,898, 35 and 18 μg copper per g dry mass (DM), respectively. These values are much higher than all identified terrestrial copper excluders, e.g., water hyacinth (Eichhornia crassipes) (Saltabas and Akcin, Toxicological and Environmental Chemistry, 41:131-134 (1994); Vesk and Allaway, Aquatic Botany, 59:33-44 (1997)), Elsholtzia haichowensis and Commelina communis (Tang and Wilke, In: “Heavy metal uptake by Elsholtzia hainchowensis Sun and Commelina communis L. grown on contaminated soils.” Luo et al., eds., International Conference of Soil Remediation, pp. 228-233 (2000), the disclosure of which is hereby incorporated by reference in its entirety) or copper hyperaccumulators—plants that can accumulate heavy metals in shoots to exceedingly high concentrations, i.e., >1000 mg kg⁻¹ (Brooks, In: “Plants that hyperaccumulate heavy metals.” Brookes, ed., Wallingford, UK:CAB International, pp. 55-94 (1998); Baker et al., In: “Phytoremediation of contaminated soil and water.” Terry et al. eds., Boca Raton, Fla., USA: Lewis Publishers, pp. 85-107 (2000)), e.g., Haumaniastrum robertti (Baker, Biorecovery, 1:81-126 (1989); Reeves et al., Mining Environmental Management, 9:4-8 (1995)), Haunaniastrum katangense (Brooks et al. In: “Remediation of soils contaminated with metals.” Proceedings of a conference on biogeochemistry of trace elements, Taipei, Taiwan, Science Reviews Ltr. Northwood USA, pp. 123-133 (1997), the disclosures of which are hereby incorporated by reference in their entireties), except for the plant Aeollanthus biformifoliiums De Wild that contains 13,700, 2,600, and 3,500 μg copper per g DM in corm, leaf, flower stems, respectively (Malaisse et al., Science, 199:887-888 (1978), the disclosure of which is hereby incorporated by reference in its entirety). Metal-rich bottom water from layers close to the sediments can be pumped onto the FPP and the pollutants removed through vertical rhizofiltration. The metal-loaded FPP can then be summarily collected and heavy metals concentrated by burning. This method is more manageable and cost-effective than the widely adopted ex-situ phytoremediation approach. It eliminates digging, transporting, and reconditioning the sludge for plant growth, and economically solves the problem of removing the metal-rich fine roots from the soil, which is often impossible.

The above-described FPP technology may also be applied to soil bioremediation, for example, by creating a sump pond at the low point of the polluted area. Water soluble pollutants such as metal ions may be washed to the sump pond by rain or man-made continuous irrigation. FPP will serve as a concentrator of the pollutants.

The FSCP method of the invention can be used to grow all sizes of plants, depending on the design of the system. Growth of perennial, herbaceous, annual plants, dwarf plants, major or minor crops, and even trees, is possible. The FSCP can be used for growing ornamental crops for landscaping or production: The FSCP can support a mixed culture of plants with aesthetic values.

Food and Other Uses

The FSCP can be used to grow food, oil, fiber, bio-fuel, spice, herbs or nutraceuticals, pharmaceuticals and other economic crops. Examples of the use of FSCPs to grow food are shown in Examples 7, 12, 14, 18, 19, and 20. For example, Sesuvium portulacastrum can be considered as a crop available for food and molecular farming. The fleshy stems of Sesuvium portulacastrum can be eaten either raw or cooked as greens (Merlin, Hawaiian Coastal Plants. Pacific Guide Books, Taipei, Taiwan, Rep. of China, p. 41 (1999), the disclosure of which is hereby incorporated by reference in its entirety). Its succulent leaves accumulate high amounts of salt, protein, mineral nutrients and dietary supplements. The concentration of sodium in the leaves increases with salinity of cultivation water (Example 14 and Table 4).

The S. portulacastrum plant cultivated in 100% seawater contains sodium ion as more than 15% of leaf dry matter (Example 14 and Table 4). Accordingly, the powder of S. portulacastrum leaves has potential use as a “phytosalt.” As shown in the table, the harvested S. portulacatrum tissue contains numerous nutrients in addition to an accumulation of salt.

Shoots of Sesuvium portulacastrum accumulate proline, a dietary supplement, to over 0.85% of dry weight (Venkatesalu and Kumar, Journal of Plant Nutrition, 17:1635-1645 (1994)). The whole plant of Sesuvium portulacastrum is rich in ecdysterone (3.5 g/kg of dry matter) (Banerji et al., Phytochemistry, 10:2225-2226 (1971), the disclosure of which is hereby incorporated by reference in its entirety), which has been commercially used as a non-hormone anabolic supplement. Ecdysterone stimulates insects to moult, thus having potential use as chemosterilants in the biological control of insect pests (Lonard and Judd, Journal of Coastal Research, 13:96-104 (1997), the disclosure of which is hereby incorporated by reference in its entirety). In addition, ecdysterone is used for cosmetics (Chinese patent application CN 86-106791 19860930, to Lin et aL; and International Patent Publication No. WO 9404132 A2, the disclosures of which are hereby incorporated by reference in their entireties). Recently, ecdysterone has been found to posses diverse medical finctions, such as antitumor activity against prostate cancer (Stockm and Campbell, “Human germline engineering—the prospects for commercial development;” from the world wide web at the following link: ess.ucla.edu/huge/Stockatc.html (2003)), anti-inflammatory (Kurmukov et al., Meditsinskii Zhurmal Uzbekistana (Journal written in Russian with abstract in English), 10:68-70 (1988)), and antioxidation (Kuz'menko, Ukr Biokhim Zh (Journal written in Russian with abstract in English), 71:35-38 (1999)), the disclosures of which are hereby incorporated by reference in their entireties.

Another useful purpose of the FSCP of the invention is in improving coastal fish habitat: FSCP will continuously provide photosynthate, predator protection, and shade to its surrounding water bodies, serving as food source and habitat to aquatic plants and animals.

The FSCP method of the invention can also be used to create a wind- and wave-break to protect seashore erosion. For example, a large-scale platform can be designed and built at strategic sites to protect the seashore. In addition to protecting the land from seashore erosion, the wind or wavebreak platforms can also provide a fish sanctuary, and can also be used for landscaping purposes. This method for protection of erosion is especially important when one considers the prediction that, at the current rate of temperature increase due to global warming, sea level will be three feet higher in 200 years (Syme and Tait, 2001, Earth Pulse: Rising tide of concern., Natl. Geog., 199:2).

The floating platforms can also be used for desalination purposes. Akulikuli has been shown to be a sodium accumulator. For lakes of increasing salinity, FSCP with ion-accumulating plants such as akulikuli can be used for desalination. Examples of ions that can be accumulated include but are not limited to ions of sodium, phosphorous, potassium, nitrogen, sulfur, boron, chloride, and the like. Water that has been desalinated can then be used directly or further processed for many purposes, such as irrigation uses, drinking water, or other water-use needs. Further, establishing fast growing plants in a transparent plastic dome floating on the ocean can provide a device for producing portable drinking water through plant transpiration, which may particularly be valuable in the drought susceptible islands. An example of pond desalination using the methods of the invention is shown in Example 22.

The above disclosure generally describes the present invention. A more complete understanding can be obtained by reference to the following specific examples which are provided herein for purposes of illustration only and are not intended to limit the scope of the invention.

### EXAMPLES

### Example 1

### Example of Making the Sheet-style FSCP With Air Filled Bags for Buoyancy

In waters that are less calm, such as coastal waters or waters during storm conditions, a more flexible system can avoid the possibility of breakage problems of the rigid framework. Accordingly, an FSCP was prepared using inflated plastic pipes and polypropylene ground cover, using the following method. The method has the added advantages of ease of assembly and transport and low cost. A sheet-style FSCP was prepared which was composed of a single layer of polypropylene ground cover folded to form narrow long bags in certain intervals (e.g., 11 inches) along the extended platform. Each bag contained two plastic pipes supporting the platform. The air pipes were made by blowing air into polyethylene tubing and sealing both ends. The plant stem was supported in between the two air pipes to allow root growth between the spaces in the bag and extrusion through the Ground Cover. Each side of the platform was clipped with plastic Locking Clips (Easy Gardener, Inc., Waco, Tex.) every ten feet. The platform unit was stretched with long nylon ropes through the Locking Clips and anchored at the ends. Each platform unit was then connected side by side with cable ties to form a large scale FSCP.

### Example 2

### Example of Making the Sheet-style FSCP Using PVC Pipe to Make a Rigid Structural Framework

Because akulikuli is a prostrate herb, a sheet-style platform system with a single layer of shade cloth/ground cover, covered on the top of the PVC pipe framework, was sufficient to support its growth on the water. The sheet-style platform was made as described in the above example, except that structural framework made of a PVC pipe was used. The framework was assembled by joining two 5 feet and two 10 feet long PVC pipes (1.5 inch in diameter) in a standard method. Short pieces of PVC pipe (1.5 inch in diameter), cut through one side, were used to facilitate connecting the shade cloth onto the PVC pipe. The shade cloth/ground cover was stretched as tight as possible, and tied to the PVC framework using 8-inch long nylon cables.

### Example 3

### Preparation of a Floating Growth Medium Package (FGMP), and Testing of Various Growth Media Using the FGMPs

One standard procedure for growth of akulikuli or other plants on a floating seawater cultivation platform is as follows. A typical FGMP illustrated in FIG. 2 was made of a polypropylene (70% or 100%) shade cloth bag (3 feet long, 1.5 feet width and 5 inch thickness). Solid culture medium, such as Polylite Expanded Polystyrene (EPS) Flakes (polylite; Pacific Allied Products, Ltd., Kapolei, Hi.) was placed in the pillow-like bag. The filled bag was sealed using a sewing machine. For experimental purposes, a small size of FGMP was made in a cylindrical shape (1 foot in diameter and 5 inches in height) (shown in FIG. 5A, 5B, 5C, 6B, 9A, and 9B). Three media were tested: 1. A mixture of 1:1 peat moss and polylite; 2. A mixture of 1:1 perlite and polylite; and 3. Polylite alone. The FGMPs were planted with akulikuli, milo and naio, and allowed to grow for several months. After seven months, there was no significant difference in growth of akulikuli, milo and naio in these three growth media. Therefore, 100% polylite was used for the culture medium. Small holes (½ inch in diameter) were cut on the top of the shade cloth to allow for transplantation of the seedlings. The space between each plant was 6 inch×12 inches. The supporting PVC pipe framework was assembled by joining two 5 feet and two 10 feet long PVC pipe (1.5 inch in diameter) in a standard method.

### Example 4

### Seedling Preparation and Transplanting to System

Akulikuli cuttings containing at least one node and two leaves were grown in plastic propagation pots containing #1 Sunshine potting mix (Sun Gro Horticulture, Inc., Bellevue, Wash.) irrigated with misting two seconds every ten minutes. After one-month of growth, the propagation pots with seedlings pot were soaked in artificial seawater at 32 to 35 ppt (parts per thousand) salinity for one week for salt acclimatization. Then the seedlings were then transplanted to the FGMP in seawater or brackish water. Six planted FGMPs were placed inside a FSCP unit and tied on the PVC framework by cable ties to form a FGMP unit. The viability of the transplanted seedlings was determined after one week of growth. Seedlings that failed to recover from the transplanting shock were replaced.

### Example 5

### Installation of the FGMP to FSCP

Transplanted FGMPs were then installed to the FSCP system. A fishnet (size of ⅜ inch) was connected under the framework of each FSCP unit to protect roots from grazing of fish. The units were connected together with two 2-feet nylon cable ties, each of which can holds approximately 270 pounds. The entire FSCP system was fixed with anchors or umbrella stands every 20 feet on both sides to prevent shifting of positions of the system.

### Example 6

### Floating Seawater Cultivation Platform Using Heavy-duty Polyethylene Sheet and Air Bubble Cushion.

One layer of air bubble cushion (packing material) is attached to the low side of heavy-duty polyethylene sheet using polycarbonate or polyethylene grommets. Lightweight polypropylene rope floating on the surface of water is used to surround an HDPE sheet, which serves as supporting material for the edges of the platform and fishnets. Reinforcing polyethylene sheet is added on the sheet every 25 feet and reinforcing HDPE is added in every corner and along the reinforcing polyethylene sheet, where nylon rope is hooked and connected to anchors. The total length of each platform is 100 feet. Approximately 800 plants are distributed in grommets with a spacing of 6×12 inches. The width of the platform varies from 4 to 6 feet. This sheet style of platform is suitable for growing akulikuli. Growth of small shrubs, such as Salicornia, can be accommodated by use of plastic tubing with a mouth (1.25 cm in outside diameter) and one-inch step. The seedling of Salicornia is covered by a thin layer of sponge and passed through the tubing. The details of this platform are illustrated in FIG. 10.

### Example 7

### Using the FSCP to Grow Akulikuli

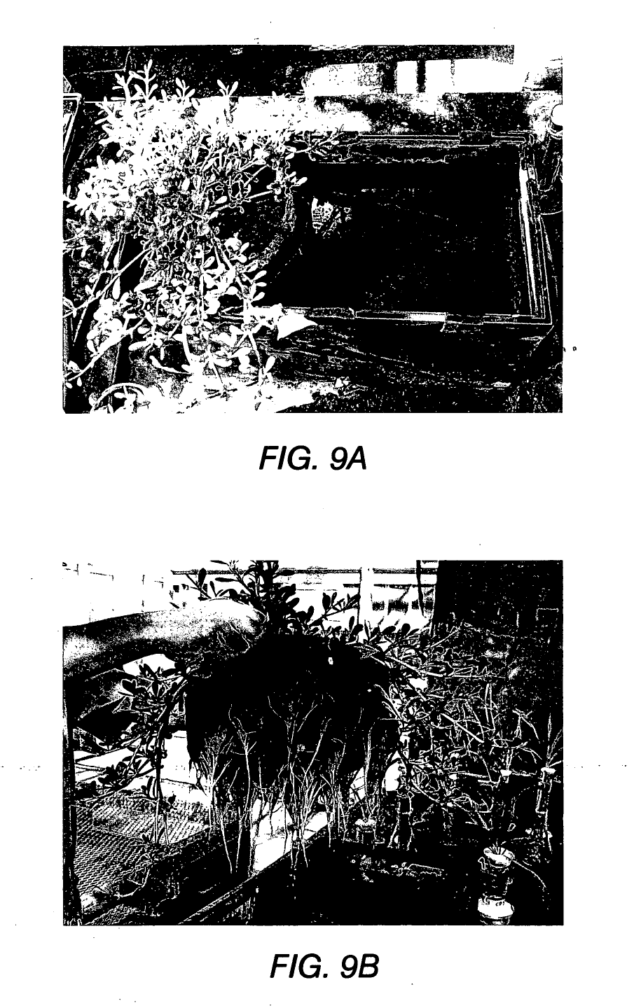

Under greenhouse conditions with addition of 5 g of controlled release fertilizer Nutricote (13N-13P-13K) (Nutricote Inc., Hawaii) per 10 gallon fish tank, akulikuli plants were grown. The plants produced 14.2 g dry root matter and 205 g dry shoot matter per ft² in five months (Table 3). In addition, akulikuli plants rapidly regenerated shoots and roots after being cut at the surface of FGMP in 100% seawater (data not shown) and brackish water (FIG. 9A and 9B).

### Example 8

### Use of the FGMP to Grow a Mangrove Tree

An FGMP system was prepared following Example 3. The system was planted with American mangrove (Rhizophora mangle). The mangrove reached five feet tall after 3.5 years of growth in 100% seawater in a greenhouse.

### Example 9

### Extraction of Copper from Seawater by Halophvtic Terrestrial Plants Using the FSCP

Akulikuli (Sesuvium portulacastrum L.), is a copper excluder (Baker, Journal of Plant Nutrition, 3:643-654 (1981)), which accumulates higher concentrations of heavy metals in the roots than that in the shoots (Table 2). Akulikuli is able to quickly establish an extensive root system first in the FPP platform, then penetrate through the platform to form a suspended root mass in seawater. Roots of plants grown in platforms on seawater for six months under greenhouse conditions were immersed in seawater amended with 35 ppm Cu for 24 hours, approximately 11-hour daytime at maximum light intensity of 600 μmol m-2 s-1 and 13-hour night time. Plant immersed roots were gently washed by hand 3 times in tap water (500 mL as same as the treatment solution) to remove excess copper. Plant tissues were separated into immersed roots, stems and leaves, and dried at 70 C for 24 hours in a vacuum oven. Metals were determined by Atomic Absorption Spectroscopy. The akulikuli root system effectively removed copper ion from seawater, and accumulated copper at levels that are higher than in previously identified terrestrial copper excluders.

TABLE 2

Concentration of copper (μg/g dry mass)

| Plant species | Root | Stem | Leaf | Total |
|---|---|---|---|---|
| Akulikuli | 4898 | 35 | 18 | 4951 |
| Beach naupaka | 190 | 40 | 23 | 253 |
| Red mangrove | 278 | 39 | 47 | 364 |
| Milo | 898 | 36 | 33 | 967 |
| Seashore paspalum | 23 | 24 | 24 | 71 |

### Example 10

### Use of FSCPs for Bioremediation of Polluted Brackish Water

A boat marina is found to be highly polluted with chemicals produced by constant boating uses. A region of the area is cordoned off from the boating traffic. A sheet-style FSCP is prepared with salt tolerant prostrate plants, such as Sesuvium. After 1 month, the water is less polluted and the FSCP (plants included) is towed to another similarly polluted corner of the marina, where the FSCP cleanses the new area. The cycle of cleansing and towing the FSCP to a new area is continued as needed.

### Example 11

### Use of FSCP for Phytoremediation of Heavy Metal Contaminated High Saline Soil

Phytoremediation of saline soils has been a particular problem, since most plants do not grow well in such soils. In this method, however, the salt tolerant plant Sesuvium plant is used, and a sump pond is designed to collect the pollutants to be removed. An FSCP is prepared, containing 50 one month old Sesuvium plants. The platform is placed into an artificially created sump pond at the low end of a soil area that is contaminated with heavy metals. The Sesuvium plants take up the polluted materials, and after 2 months, the plants are harvested and subsequently incinerated to recover the heavy metal contaminants.

### Example 12

### Biomass Production of Sesuvium portulacastrum

Biomass production of Sesuvium portulacastrum was determined under greenhouse conditions in 10 gallon of fish tanks containing sediments and brackish water from Heeia Fishpond, Kaneohe, Hi. Each fish tank was amended with 5 g of controlled release fertilizer (13N-13P-13K) (Nutricote Inc.,. The initial total dissolved nitrogen and dissolved phosphorus were 1.9 and 0.2 mg/L, respectively. After 144-day experiments, the total dissolved N and dissolved P in planted tanks were 0.027 and 0.20 mg/L in the planted tank, respectively. Half of the surface of the tank was covered with a round floating seawater cultivation platform (11 inch in diameter) with one plant in the center. Values are means of three replicates. Numbers in parenthesis are standard deviations.

TABLE 3

| | Biomass (dry weight, g) | | | |
|---|---|---|---|---|
| | | | Mass | Growth rate |
| | Day 0 | Day 144 | production | (g/plant/day) |
| Shoot | 15.0 (4.4) | 220.1 (7.4) | 205 | 1.42 |
| Root | 3.9 (0.3) | 18.1 (4.5) | 14.2 | 0.1 |

### Example 13

### The Catching Net Improves Root and Shoot Biomass

To determine whether an additional netting layer below the plant roots (to protect from predators feeding on roots) affects plant growth significantly, Akulikuli plants were placed on FSCPs with or without a catching net layer in coastal water at Heeia Fishpond, Hi. The plants were allowed to grow for 5 months, and were then harvested to compare root and shoot growth. The results (FIG. 8A and 8B) demonstrate that the catching net significantly protected roots from grazing by fish and marine animals, increasing in root and shoot biomass compared to plants outside of the net.

### Example 14

### Tissues of Sesuvium portulacastrum can be Harvested to Prepare a “Phatosalt”

To determine whether Sesuvium portulacastrum shoots and roots can be harvested to prepare a nutritious “phytosalt,” the nutrient content of tissues of Sesuvium portulacastrum was measured. The plants were grown in brackish and 100% seawater (salt water) in a greenhouse. The dry weight of shoot and root is approximately 19.7% and 11.2% of fresh weight, respectively. The nutrient content of the harvested Sesuvium roots and shoots is shown below in Table 4. Note that the leaf material was able to accumulate high levels of Na⁺ when grown in seawater.

TABLE 4

| | Brackish water* | | Seawater** | | |
|---|---|---|---|---|---|
| Parameter | Shoot | Root | Stem | Leaf | Root |
| | % of Dry Matter | | | | |
| Crude Protein | 4.85 | 5.85 | NEW | NA | NA |
| | | | ZEALAND | | |
| Ash | 19.21 | 14.64 | NEW | NA | NA |
| | | | ZEALAND | | |
| Crude Fat | 1.91 | 1.33 | NA | NA | NA |
| Lignin | 12.45 | 12.19 | NA | NA | NA |
| Cellulose | 4.15 | 11.5 | NA | NA | NA |
| Na | 4.86 | 1.71 | 7.13 | 15.26 | 3.38 |
| Total N | 0.78 | 0.94 | NA | NA | NA |
| P | 0.19 | 0.13 | 0.45 | 1.15 | 0.75 |
| K | 3.07 | 1.8 | 0.63 | 2.07 | 3.99 |
| Ca | 0.51 | 0.34 | 0.80 | 0.43 | 0.18 |
| Mg | 0.41 | 0.47 | 0.47 | 0.66 | 0.65 |
| | μg/g | | | | |
| Fe | 89 | 143 | 46 | 171 | 115 |
| Mn | 64 | 18 | 48 | 26 | 28 |
| Zn | 14 | 107 | 48 | 26 | 223 |
| Cu | 20 | 38 | 8 | 15 | 36 |
| B | 21 | 58 | 38 | 77 | 40 |

*Salinity is 18 ppt.
**Salinity is 32 ppt.
NA means that data were not analyzed.

### Example 15

### Method of Determining Whether a Plant Variety Thrives in the FSCP System

Artificial seawater is prepared. Six-week old tomato test plants are first weighed, then are transplanted to a FMGP style FSCP in containers of artificial seawater, diluted to either 25%, 50%, 75%, and 100% artificial seawater. At 2 week, 1 month, 2 month, and 3 month intervals, plants are harvested and reweighed (or measured). Growth is determined. Plants with increased weight or size are able to thrive in the seawater system.

### Example 16

### Method of Determining if a Plant Variety can Adapt to the FSCP System

In some situations, a plant may not survive if suddenly placed into the high saline environment of an FSCP system, but may be able to survive and thrive if slowly adapted to the high salinity environment. A method of adapting plants to a higher salinity environment is described below.

Seeds of squash plants are planted in normal soil and irrigated with a plant nutrient solution for 2 months. The plants are then removed from the soil, and carefully replanted in a FMGP. The FMGP is placed in 1% artificial seawater for 1 week, 5% artificial seawater the next week, 10% artificial seawater the next week, 20% artificial seawater the next week, with a continued 10% weekly increase. Plants that survive and thrive on this process are able to adapt to high salinity and can be used for the FSCP cultivation. Plants that survive in 50% seawater but not 100% seawater are selected as candidates for bay or estuary located FSCPs, while plants that can grow in 100% seawater can be located in coastal waters or in the open ocean. Nutrient solutions and drip irrigation are provided to some of the test plants, to determine whether this method helps their survival or increases the salinity of the seawater at which they can survive.

### Example 17

### Use of FSCPs to Clean Suspended Particulate Material in a Brackish Body of Water

The turbidity of a brackish water is measured. Three Sesuvium plants are placed in each of nine 1′ by 1′ FGMP packages which are connected together to a PVC support structure. The FSCP is placed in the turbid brackish water for 1 month. Turbidity of the water is measured twice a week. The turbidity of the brackish water is lowered by 50% using this method.

### Example 18

### Use of FSCPs to Grow Food and Ornamental Crops

Sunflower plants are started in soil and transplanted to a FMGP growing in a calm bay, where the salinity of the bay is about 15 ppt. The plants are given supplemental drip irrigation which includes nutrients. The stalks are supported further by additional lightweight wire scaffolding that rises from the platform up to three feet above the waterline. The flowers are harvested for the commercial floral market, and seeds are harvested for food.

### Example 19

### Use of FSCPs to Grow Vegetables and Fruit

Zucchini squash seeds and salt-tolerant melon seeds are planted directly in the FMGPs which are filled with ½ potting soil, ½ bark chips. Slow release fertilizer is added to the package. The FMGPs are linked together to form a FSCP, with plastic air filled tubing used to keep the structure afloat. The FSCP is located in coastal waters near the mouth of a bay, where the salinity is approximately 28 ppt. A solar powered pump system is used to transfer fresh water from a storage area attached to the platform through the tubing of the drip irrigation system. In this way, the platform can be irrigated without the need for man power or external electricity to run the pumping or timing system. To take advantage of the fresh water contained in rainfall, a sloping platform extension is fashioned to slope rainwater down to a holding area. The zucchini and melons are harvested as they become ripe.

### Example 20

### Use of FSCPs to Grow Genetically Modified Vegetables which Overexpress Genes Conferring Salt Tolerance

Tomato seedlings which have been genetically engineered to express the yeast HAL1 gene following the method of Gisbert, 2000 (Plant Physiol., 123:393-402) are adapted to 18 ppt salinity over a 1 month period of growth on a FSCP in a greenhouse. The plants are then transplanted to 20 FGMPs (one plant per FGMP) containing bark chips, perlite, peat, and yard waste. The FGMPs are linked together to form one outdoor FSCP which is located in Heeia Fishpond, Kaneohe, Hi. The plants are irrigated using drip irrigation supplemented with fertilizer. The tomato fruits are harvested when nearly ripe.

### Example 21

### Use of FSCPs to Grow Genetically Modified Plants that have Increased Salt Tolerance and Can be used for Bioremediation in Saline Bodies of Water

Wild mustard plants are genetically engineered to overexpress the Arabidopsis thaliana gene AtNHX1, which has been found to confer salt tolerance to Arabidopsis, following the method of Apse, et al., 1999 (Science 285:1256-1258). The plants are adapted to a 50% seawater pond over a 2-week period, and are then placed in an outdoor fertilizer-polluted brackish pond which has the salinity of about 50% seawater. The ability of the plants to thrive and improve the water quality is measured in comparison to non-engineered wild mustard plants, and in comparison to salt tolerant species such as Sesuvium. Using this method, the wild mustard plants are able to remove some of the pollutants and improve the water quality.

### Example 22

### Use of FSCPs for Desalination of Salt Water Ponds

Certain salt-tolerant plants, such as Akulikuli, are capable of accumulating salt in their tissues. This can be used as a means of removing excess salt from a pond. Akulikuli plants are grown on a FSCP in a brackish pond, with minimal nutrient addition. The salt-rich tissue is harvested every 2 months. After 1 year, the salinity of the pond is measured. The use of this method lowers the salinity of the pond. The salt-reduced water can then be used, for example, for irrigation of golf course turf grass or crops.

### Example 23

### Use of FSCPs to Remove Excess Nitrogen and Other Contaminants from Green, Brackish Ponds

A brackish pond, having a salinity of 8 ppt is located which is receiving excess fertilizer contaminants from the run off from the nearby agricultural fields. The high nitrogen and other fertilizer components have turned the pond green with microalgae. To prevent further contamination and to cleanse the pond, FSCP platforms are made, upon which are planted Nuttall alkali grass and Canadian wild rye. The platforms cleanse the pond by removing excess nitrogen and other nutrients. Additionally, the FSCP platforms suppress algae growth through allelopathy. Within 6 months, the pond is no longer green. Additionally, the grasses on the FSCPs provide aesthetic enhancement and a habitat for several bird species. In summary, using the FSCP method has resulted in removing contaminants from the pond and improving the pond area.

It will be appreciated that no matter how detailed the foregoing appears in text, the invention can be practiced in many ways. Thus, although this invention has been described in terms of certain preferred embodiments, other embodiments which will be apparent to those of ordinary skill in the art in view of the disclosure herein are also within the scope of this invention. Accordingly, the scope of the invention is intended to be defined only by reference to the appended claims and any equivalents thereof. Each document cited herein is incorporated herein by reference in its entirety.

1. A plant cultivation system for growing terrestrial plants in saline water, comprising:
a plant support comprising a buoyant portion; and
at least one terrestrial plant in contact with the plant support, wherein the plant support is buoyant in the saline water, and wherein and at least a portion of the plant contacts the saline water.

2. The system of claim 1, wherein the saline water comprises water selected from the group consisting of seawater, brackish water, lake water, groundwater, pondwater and water in a reclamation, remediation, or cropping system.

3. The system of claim 1, wherein the saline water is in a location selected from the group consisting of open ocean, a coastal area, an estuary, a delta, a pond, a sump pond, a lake, an aquifer, a water reclamation facility, a phytoremediation site, a harbor, a marine agriculture farm, and a desalination facility.

4. The system of claim 1, wherein the saline water further comprises a contaminant selected from the group consisting of a pesticide, an organic pollutant, a PCB, a hydrocarbon, a metal ion, nitrogen, phosphorous, and potassium.

5. The system of claim 1, wherein the metal ion is selected from the group consisting of lead, mercury, cadmium, arsenate, copper, and zinc.

6. The system of claim 1, wherein the plant support comprises a sheet material in contact with a buoyant edge or frame.

7. The system of claim 1, wherein the plant support comprises a growth medium.

8. The system of claim 7, wherein the growth medium is at least partially contained in a housing.

9. The system of claim 8, wherein the buoyant portion is selected from at least one of the group consisting of: the growth medium and the housing.

10. A buoyant platform for growing terrestrial plants in saline water, comprising:
a sheet capable of being suspended at or near a surface of a body of saline water;
at least one buoyant support member in contact with the sheet; and
at least one terrestrial plant, plant part, or seed positioned in contact with the sheet such that at least a part of the terrestrial plant, plant part, or seed can also contact the saline water.

11. The buoyant platform of claim 10, wherein the at least one buoyant support member forms a supporting structure for the platform.

12. The buoyant platform of claim 10, wherein the buoyant support member comprises a material selected from the group consisting of a natural material, a synthetic material, wood, bamboo, plastic, polypropylene, steel, fiberglass, foam, plastic, and rubber.

13. The buoyant platform of claim 10, wherein the sheet comprises a material selected from the group consisting of: shade cloth, a plastic film, netting, a textile, ground cover, screen, a woven material, a nonwoven material, bubble wrap, and styrofoam.

14. The buoyant platform of claim 10, wherein a space for growth of a terrestrial plant is present in a region between two buoyant support members.

15. The buoyant platform of claim 10, further comprising an irrigation system.

16. The buoyant platform of claim 15, wherein the irrigation system delivers a liquid comprising at least one member of the group consisting of evaporative water, rainwater, transpiration water, and freshwater.

17. The buoyant platform of claim 16, wherein the irrigation system further delivers at least one material selected from the group consisting of: a fertilizer, a nutrient, a mineral, and a plant growth regulator.

18. The buoyant platform of claim 17, wherein the irrigation system further comprises means of collecting irrigation water, wherein the irrigation water has a lower salinity than the saline water.

19. The buoyant platform of claim 17, wherein the irrigation system further comprises means of storing the irrigation water.

20. A buoyant platform for growing terrestrial plants at a surface of a saline body of water, comprising:
at least one growth medium capable of being suspended at a surface of the saline body of water, wherein the growth medium comprises at least one terrestrial plant, plant part, or seed; and
at least one buoyant support member supporting the growth medium.

21. The buoyant platform of claim 20, wherein the growth medium comprises at least one substance selected from the group consisting of: peat, peat moss, an artificial soil component, natural soil, a soil amendment, a hydrophobic particle, an organic fertilizer, and a plant growth nutrient, and manure.

22. The buoyant platform of claim 20, wherein the growth medium is contained in a housing, the housing comprising a material selected from the group consisting of: shade cloth, a plastic film, netting, a textile, ground cover, screen, a woven material, a nonwoven material, bubble wrap, and styrofoam.

23. The buoyant platform of claim 20, wherein an evaporation-protective layer is provided at a surface above the growth medium package to inhibit contact of the growth medium with air.

24. A method of growing a terrestrial plant in saline water, comprising:
providing a buoyant growth platform capable of being suspended at a surface of a body of saline water;
placing plant material in the platform, such that at least a portion of the plant material is contacted by the saline water; and
growing at least one plant from the plant material while the platform is afloat in the saline water.

25. The method of claim 24, wherein the plant material is selected from the group consisting of a seed, a cutting, a root, a whole plant, and a tuber.

26. The method of claim 24, wherein the plant material is contacted with the saline water by at least one of the group consisting of: direct contact, wicking, and irrigation.

27. The method of claim 24, further comprising harvesting from the growth platform at least one item selected from the group consisting of: a whole plant, a plant part, an inflorescence, a fruit, a flower, a seed, pollen, a leaf, a root, a tuber, a meristem, and a shoot.

28. The method of claim 27, further comprising use of the harvested plant material in a product or process selected from the group consisting of: food, oil extraction, fiber, fuel, spice, herbal formulation, a nutraceutical, a pharmaceutical, an economic crop, a phyto-salt, bioremediation, contaminant sequestration, a feed, a dye, a building material, and an industrial raw material.

29. The method of claim 24, wherein the plant is selected from the group consisting of: Salicornia spp., Rhizophora mangle, Batis maritime, Sesuvium portulacastrum, Myoporum sandwicense, Thespesia populanea, and Scaevola taccada.

30. The method of claim 24, wherein the plant is a cultivated crop plant.

31. A method of improving a quality of a body of saline water containing an undesired substance, comprising:
providing a buoyant growth platform capable of being suspended at a surface of a body of saline water containing an undesired substance;
placing plant material in the platform, such that at least a portion of the plant material can be contacted by the water; and
growing the plant material in presence of the water;
removing the substance from the water, through accumulation of the substance in the plant material.

32. The method of claim 31, wherein the substance comprises an organic compound, diesel fuel, gasoline, a metal, a pesticide, an organic pollutant, a PCB, a metal ion, nitrogen, phosphorous, potassium.

33. A method of bioremediation of a ground area containing an undesired substance, comprising:
providing a sump pond, comprising water, at a low point of a ground area, wherein the ground area contains an undesired substance;
providing a buoyant growth platform capable of being suspended at a surface of a the sump pond;
placing plant material in the platform, such that at least a portion of the plant material can be contacted by the water; and
growing the plant material in presence of the water;
removing the substance from the water, through accumulation of the substance in the plant material.

34. The method of claim 33, wherein water is added to the pond by leaching the ground area with water.

35. The method of claim 33, wherein the plant material is harvested.

36. The method of claim 33, wherein steps of the method are repeated.

37. A method of improving a saline fish habitat, comprising:
providing a buoyant growth platform capable of being suspended at a water surface of a saline fish habitat;
placing plant material in the platform, such that at least a portion of the plant material can be contacted by the water; and
growing the plant material in presence of the water under conditions permitting the growing plant material to improve the fish habitat.

38. The method of claim 37, wherein the plant growth permits at least one improvement selected from the group consisting of: providing a food source to the fish, providing shelter to the fish, encouraging formation of a community of organisms beneficial to the habitat, removing an undesired substance from the water, and depositing a desired substance into the water.

39. A method of protecting land from seashore erosion, comprising:
providing a buoyant growth platform capable of being suspended in saline water adjacent a seashore;
placing plant material in the platform, such that at least a portion of the plant material can be contacted by the water; and
growing the plant material in presence of the saline water to produce a break to protect against seashore erosion.

40. The method of claim 39, wherein the break has at least one function selected from the group consisting of: a wind break, a wave break, a fish sanctuary, and a landscaping feature.

41. A method of desalinating saline water, comprising:
providing a buoyant growth platform capable of being suspended in saline water adjacent a seashore;
placing plant material of an ion-accumulating plant in the platform, such that at least a portion of the plant material can be contacted by the water; and
growing the plant material in presence of the saline water such that a salt ion is accumulated in the plant material and removed from the water.

42. The method of claim 41, wherein the ion is at least member of the group consisting of: sodium, phosphorous, potassium, nitrogen, sulfur, and boron.

43. The method of claim 41, wherein the ion-accumulating plant is Sesuvium portulacastrum.

44. A method of screening a plant variety for an ability to thrive in saline water, comprising:
providing a buoyant growth platform capable of being suspended in saline water;
determining a first measure of at least one characteristic of material of a test plant variety;
placing the plant material in the platform, such that at least a portion of the plant material can be contacted by the saline water;
allowing a period for growth of the plant material;
thereafter determining a second measure of the at least one characteristic of the plant material; and
assessing ability of the plant material to thrive in saline water based upon a comparison of the first measure and the second measure.

45. The method of claim 44, wherein the characteristic comprises at least one member of the group consisting of: biomass, size, shape, color, protein content, sugars content, growth rate, and developmental stage.

46. The method of claim 44, wherein material of the test plant variety is subjected to mutagenesis prior to or during growth.
